(19) United States
(12) Patent Application Publication
(10) Pub. No.: US 2025/0106526 A1
(43) Pub. Date: Mar. 27, 2025

(54) BYSTANDER CAPTURE PRIVACY PROTECTION DEVICES AND SYSTEMS, AND METHODS OF USE THEREOF

(71) Applicant: Meta Platforms Technologies, LLC, Menlo Park, CA (US)

(72) Inventors: Juho Lee, San Mateo, CA (US); Bruce Wang, Palo Alto, CA (US); Vikramaditya Dangi, San Francisco, CA (US); Jaykishan Dakshesh Choksi, Santa Clara, CA (US); Nan Wang, Sunnyvale, CA (US); Hao Huang, Milpitas, CA (US)

(21) Appl. No.: 18/890,575

(22) Filed: Sep. 19, 2024

Related U.S. Application Data
(60) Provisional application No. 63/585,843, filed on Sep. 27, 2023.

(51) Int. Cl. H04N 23/74; G06T 7/80; G06V 10/60

(52) U.S. Cl. CPC H04N 23/74; G06T 7/80; G06V 10/60

(57) ABSTRACT

Systems and methods for detecting tampering with bystander privacy indicators are disclosed. A method performed at a head-wearable device worn by a user includes detecting, via an ambient light sensor of a head-wearable device, a first amount of light in an environment, and detect, via the imaging device of the head-wearable device, a second amount of light in the environment. The method further includes, responsive to user input for capturing image data via the imaging device of the head-wearable device, determining a brightness ratio. The brightness ratio is based on a relationship between the first amount of light and the second amount of light in the environment. The method includes, in accordance with a determination that the brightness ratio satisfies a tamper threshold, capturing image data; and, in accordance with a determination that the brightness ratio does not satisfy the tamper threshold, forgoing capturing image data.

### TECHNICAL FIELD

This disclosure relates generally to head-wearable devices including indicators for notifying bystanders of a camera capturing image data, including but not limited to methods for detecting attempts to tamper with and/or conceal the indicators from bystanders.

### RELATED APPLICATION

This application claims priority to U.S. Provisional Application No. 63/585,843, filed Sep. 27, 2023, entitled “Techniques For Bystander Capture Privacy Protection, And Systems And Methods Of Use Thereof,” each of which is hereby incorporated by reference in their entirety.

### BACKGROUND

Cameras and other recording devices have become prevalent in modern-day society. As cameras have become smaller and increasingly portable, privacy concerns have also increased—specifically, bystanders' ability to recognize when a camera is active so that they can take appropriate measures to avoid being captured in an image or to readily identify when they are the subject of an image. Existing systems and methods use light indicators to notify bystanders; however, such system and methods are easily circumvented by malicious actors. For example, malicious actors can tamper with and/or conceal the light indicators such that bystanders are not aware of an active camera.

As such, there is a need to address one or more of the above-identified challenges. A brief summary of solutions to the issues noted above can be found below.

### SUMMARY

The methods, systems, and devices described herein provide additional safeguards to prevent the concealment of and/or tampering with privacy indicators that are configured to notify bystanders of an active camera or other recording device. Specifically, the methods, systems, and devices disclosed herein relate to the detection of tampering with and/or concealment of privacy indicators (e.g., light-emitting diodes that notify bystanders when an imaging device is active) of a head-wearable device. The head-wearable device uses one or more sensors to detect attempts to tamper with the privacy indicators and, when tampering is detected, disable an associated imaging device. The one or more sensors can be associated with the privacy indicators such that the one or more sensors capture data when the privacy indicators are illuminated. The privacy indicators are associated with an imaging device of the head-wearable device such that the privacy indicators are illuminated when the imaging device is active and/or capturing image data. The sensor's field of views can be matched (e.g., one sensor's field of view can be matched with another sensor's field of view, and vice versa) for optimized performance. Although the primary examples provided herein relate to a head-wearable device including an imaging device, methods, systems, and devices described herein can be applied to any electronic device including an imaging device and/or communicatively coupled with an imaging device.

One example of privacy-indicator tamper detection at a head-wearable device is described herein. The example method is performed at a head-wearable device worn by a user and including an imaging device, one or more sensors, and a privacy indicator. The method includes detecting, via an ambient light sensor of a head-wearable device, a first amount of light in an environment and detecting, via the imaging device of the head-wearable device, a second amount of light in the environment. The method further includes, responsive to user input for capturing image data via the imaging device of the head-wearable device, determining a brightness ratio. The brightness ratio is based on a relationship between the first amount of light and the second amount of light in the environment. The method includes, in accordance with a determination that the brightness ratio satisfies a tamper threshold, capturing image data; and, in accordance with a determination that the brightness ratio does not satisfy the tamper threshold, forgoing capturing image data.

In another example, a head-wearable device configured to detect privacy-indicator tampering is disclosed. The head-wearable device includes one or more imaging devices, one or more sensors, one or more privacy indicators, and one or more programs, where the one or more programs are stored in memory and configured to be executed by one or more processors. The one or more programs include instructions for performing operations. The operations include detecting, via an ambient light sensor of a head-wearable device, a first amount of light in an environment, and detecting, via the imaging device of the head-wearable device, a second amount of light in the environment. The operations further include, responsive to user input for capturing image data via the imaging device of the head-wearable device, determining a brightness ratio. The brightness ratio is based on a relationship between the first amount of light and the second amount of light in the environment. The operations include, in accordance with a determination that the brightness ratio satisfies a tamper threshold, capturing image data; and, in accordance with a determination that the brightness ratio does not satisfy the tamper threshold, forgoing capturing image data.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1N illustrate an example bystander capture privacy protection method, in accordance with some embodiments.

FIGS. 2A-2D illustrate example head-wearable devices, in accordance with some embodiments.

FIGS. 3A-3B illustrate sensor data and image data generated by an example bystander capture privacy protection method, in accordance with some embodiments.

FIGS. 4A and 4B illustrate flow diagrams of a detailed method for bystander capture privacy protection, in accordance with some embodiments.

FIG. 5 illustrates a flow diagram of another detailed method for bystander capture privacy protection, in accordance with some embodiments.

FIG. 6 illustrates a flow diagram of a method for bystander capture privacy protection, in accordance with some embodiments.

FIGS. 7A and 7B illustrate example AR systems, in accordance with some embodiments.

FIGS. 8A and 8B illustrate an example wrist-wearable device 800, in accordance with some embodiments.

FIGS. 9A-9C illustrate example head-wearable devices, in accordance with some embodiments.

FIGS. 10A and 10B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of AR systems. AR, as described herein, is any superimposed functionality and/or sensory-detectable presentation provided by an AR system within a user's physical surroundings. Such artificial realities can include and/or represent virtual reality (VR), augmented reality, mixed artificial-reality (MAR), or some combination and/or variation of one or more of these. For example, a user can perform a swiping in-air hand gesture to cause a song to be skipped by a song-providing API providing playback via, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

AR content can include completely generated content or generated content combined with captured (e.g., real-world) content. The AR content can include video, audio, haptic events, or some combination thereof, any of which can be presented in a single channel or in multiple channels (such as stereo video that produces a three-dimensional effect to a viewer). Additionally, in some embodiments, AR can also be associated with applications, products, accessories, services, or some combination thereof, which are used, for example, to create content in an AR and/or are otherwise used in (e.g., to perform activities in) an artificial reality.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device) and/or detected via image data captured by an imaging device of a wearable device (e.g., a camera of a head-wearable device)) or a combination of the user's hands. “In-air” means, in some embodiments, that the user hand does not contact a surface, object, or portion of an electronic device (e.g., a head-wearable device or other communicatively coupled device, such as the wrist-wearable device); in other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit) detected by a wearable device worn by the user and/or other electronic devices in the user's possession (e.g., smartphones, laptops, imaging devices, intermediary devices, and/or other devices described herein).

As described herein, the privacy-indicator tamper detection systems, devices, and methods disclosed herein protect bystanders from being inadvertently or maliciously captured in an image. The systems, devices, and methods described herein disable the use of an imaging device when a tampering event is detected such that bystanders are protected. As described herein, systems, devices, and methods are adjustable and can operate in different environments.

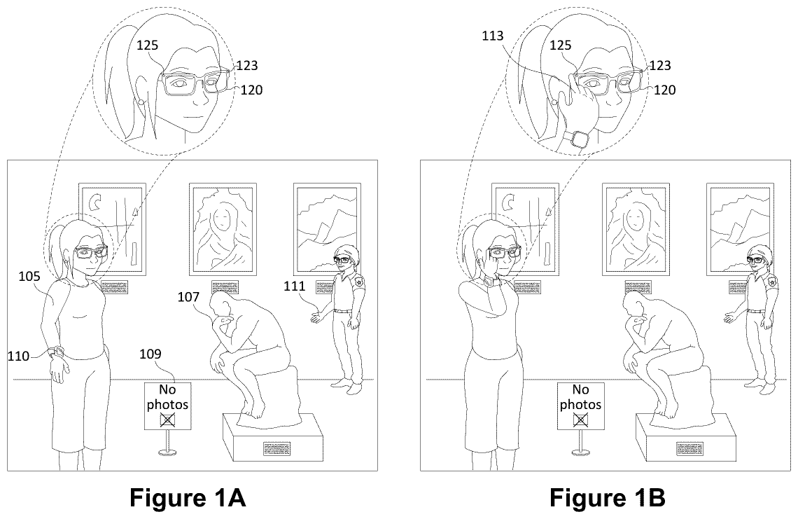

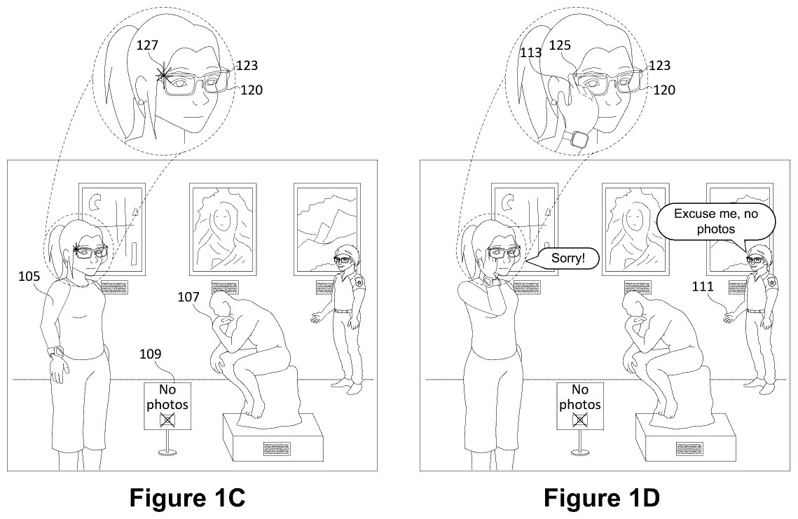

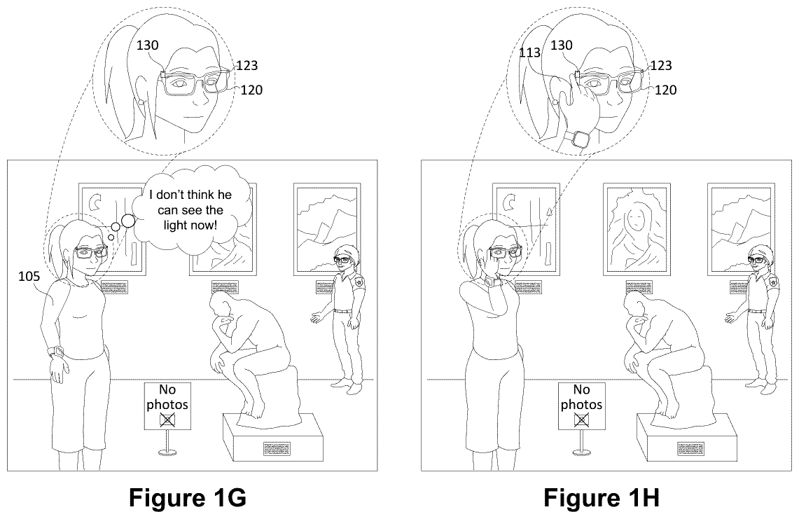

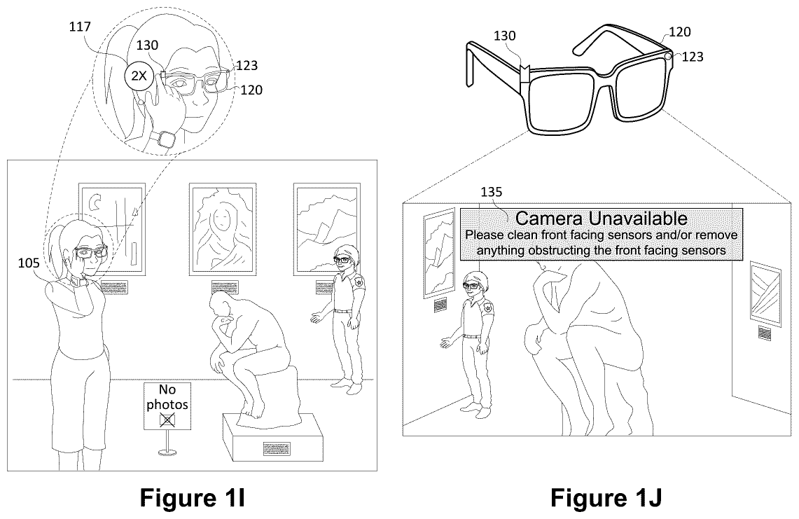

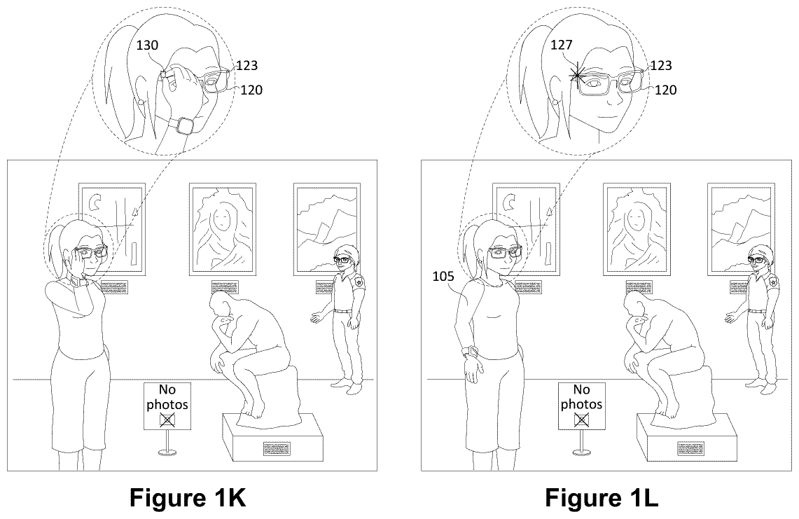

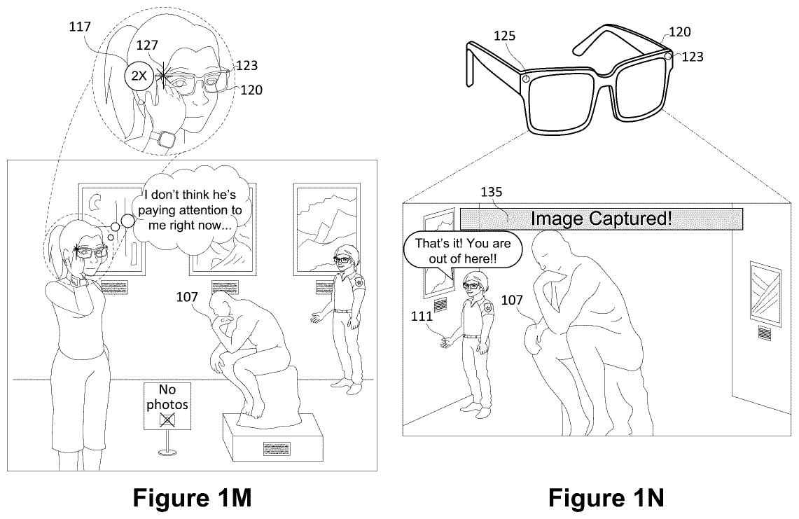

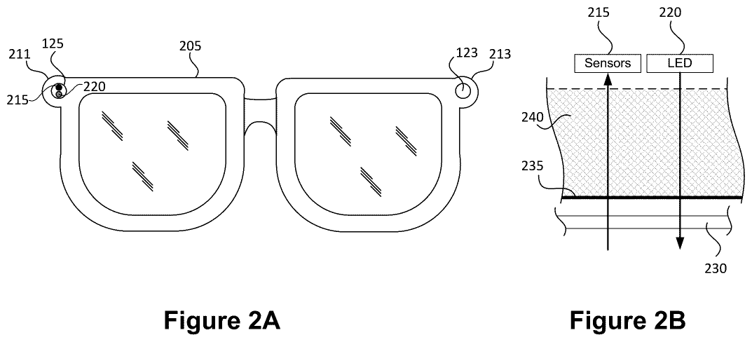

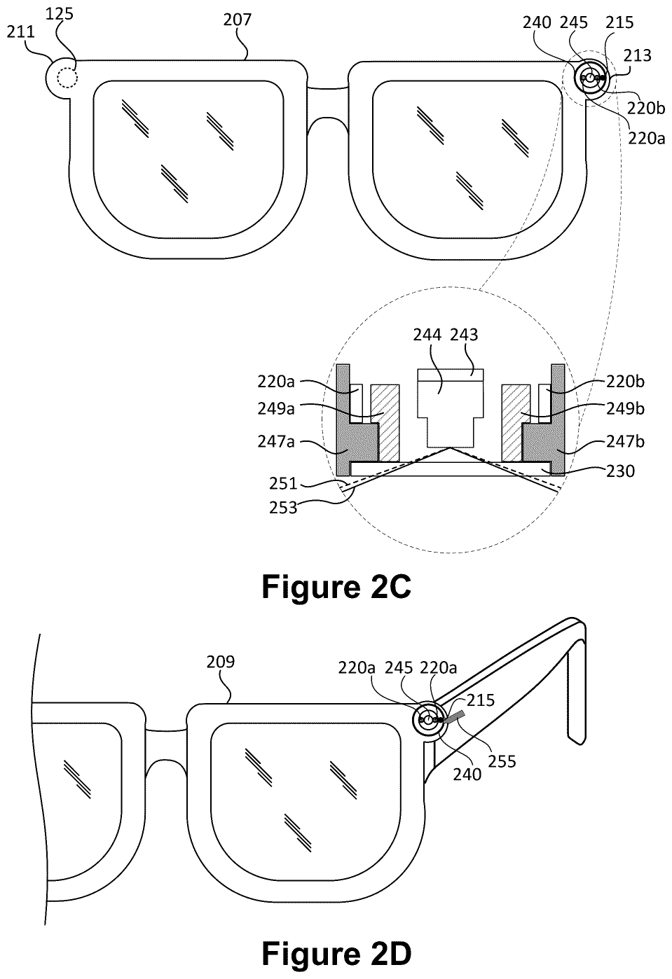

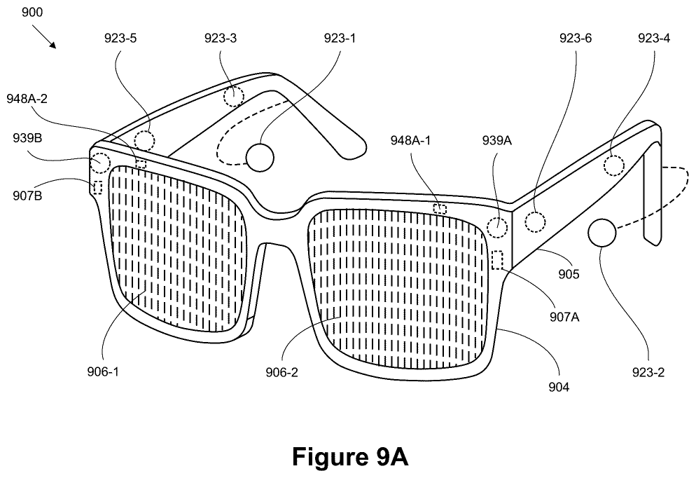

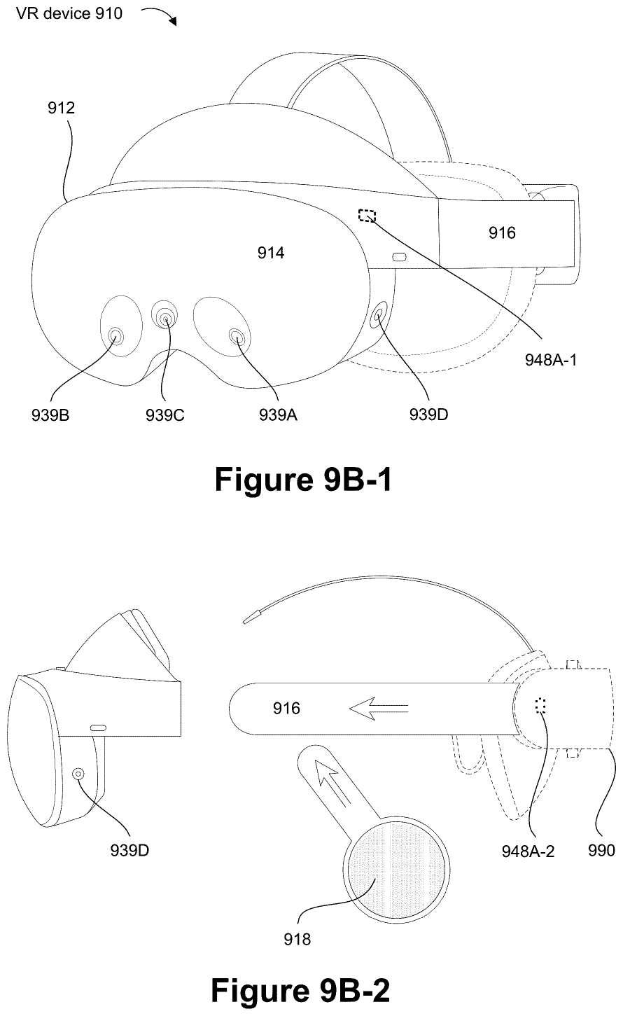

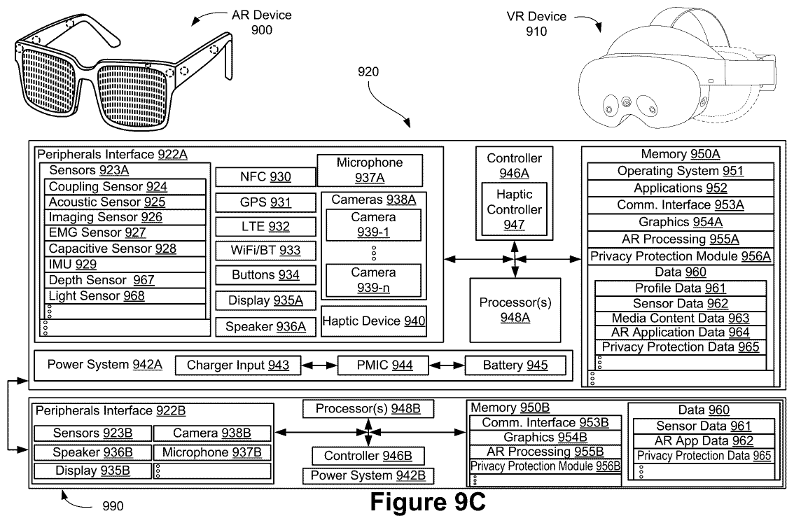

FIGS. 1A-1N illustrate an example bystander capture privacy protection technique, in accordance with some embodiments. The bystander capture privacy protection technique can be performed at an electronic device (or one or more communicatively coupled electronic devices) including at least an imaging device, one or more sensors, and a privacy indicator (which is associated with the imaging device of the electronic device such that, when the imaging device is active, the privacy indicator is illuminated). For example, in FIGS. 1A-1J, the example bystander capture privacy protection technique is performed by a head-wearable device 120 including at least a display 935 (FIG. 9C), an imaging device 123 (e.g., a camera or imaging sensor), a privacy protection unit 125 (e.g., which can include one or more sensors 215 and a privacy indicator 220; FIG. 2A), memory 950 (FIG. 9C) storing instructions for performing one or more bystander capture privacy protection techniques, and one or more processors (e.g., processors 948; FIG. 9C) for executing the instructions stored in memory 950. As discussed below, the bystander capture privacy protection technique is configured to detect tampering with, concealment of, and/or obstruction of the privacy indicator that would not allow bystanders to visually perceive the privacy indicator when illuminated.

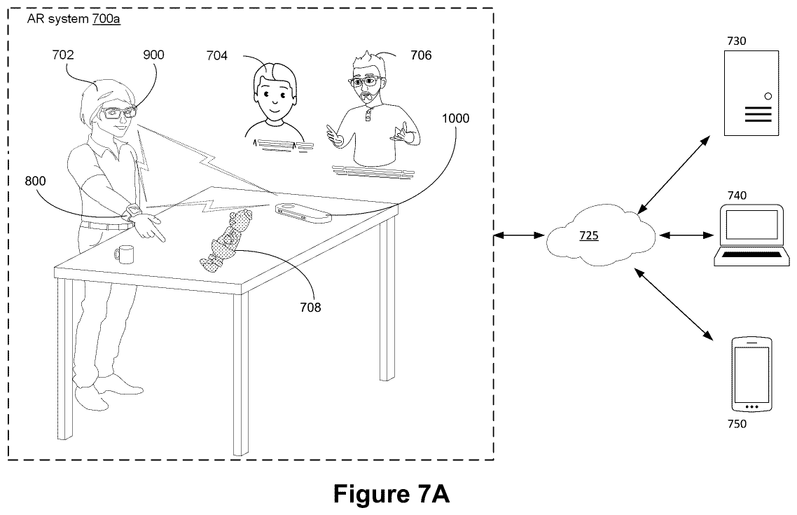

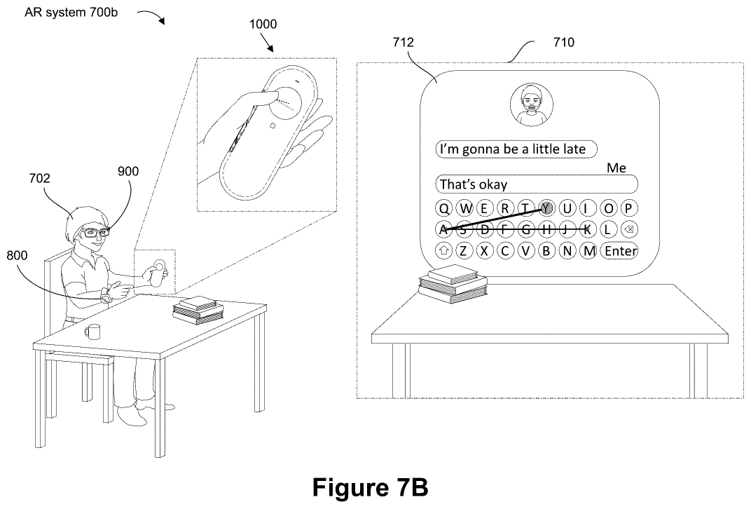

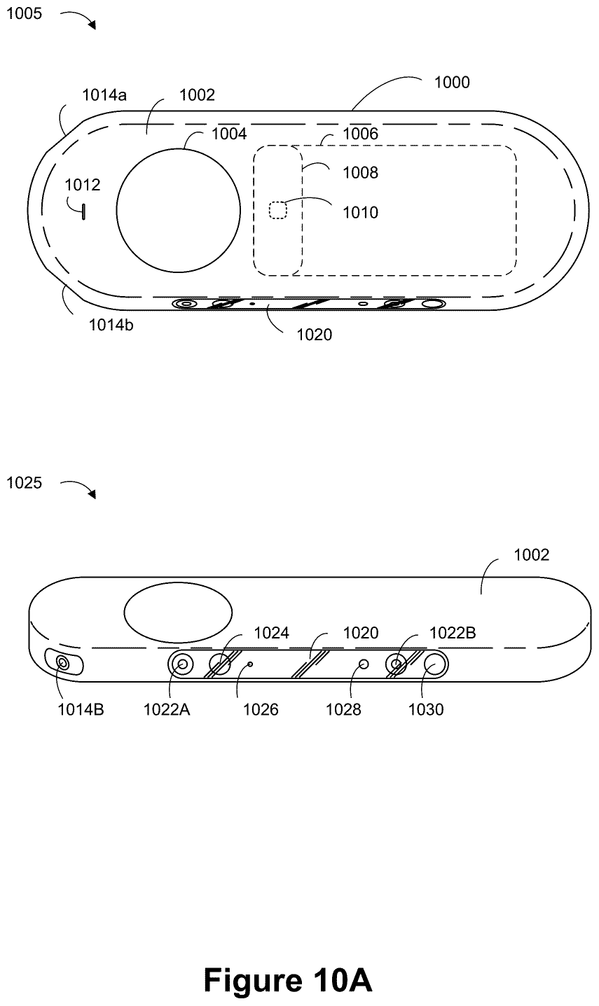

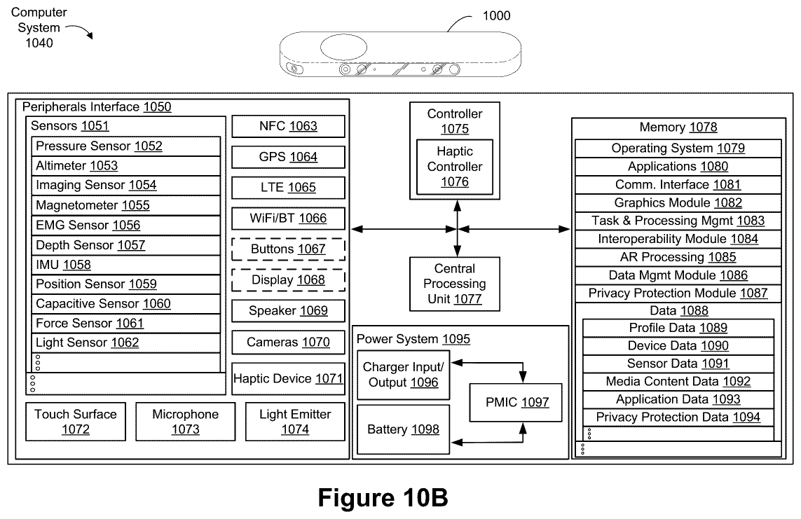

Turning to FIG. 1A, a user 105 wearing a head-wearable device 120 explores a museum (an example private or public space) and approaches an exhibit 107. The museum restricts the photographing of the exhibit 107 and has posted a sign 109 and assigned a security guard 111 to notify and/or prevent visitors from taking photos of the exhibit 107. The user 105, unaware of the restriction or choosing to ignore the restriction, initiates the imaging device 123 of the head-wearable device 120 and/or provides a command to capture image data via the imaging device 123. Specifically, the user 105 performs a user input that, when detected by the head-wearable device 120 and/or a communicatively coupled device (e.g., a wrist-wearable device 110, a handheld intermediary processing device 1000 (FIGS. 10A and 10B), or other devices described below in reference to FIGS. 7A and 7B), causes the head-wearable device 120 to turn on the imaging device 123 and/or capture image data using the imaging device 123.

The user input can be a touch input gesture 113 performed at the head-wearable device 120 and/or a communicatively coupled device, a voice command, and/or a hand gesture. For example, as shown in FIG. 1B, the user 105 performs a touch input gesture 113 at a portion of the head-wearable device 120 (e.g., temple arm of the head-wearable device 120) to initiate the imaging device 123. In some embodiments, the head-wearable device 120 alone or in conjunction with another communicatively coupled device (e.g., the wrist-wearable device 110) detects the user input. For example, the head-wearable device 120 can detect a hand gesture performed by the user 105 by processing image data captured by the imaging device and recognizing hand gestures performed by the user 105. Alternatively, the user 105 can perform hand gestures that are detected by the wrist-wearable device 110 and cause the wrist-wearable device 110 to provide instructions to the head-wearable device 120 for initiating imaging device 123. The above examples are non-limiting, and different user input methods can be used to provide commands to the head-wearable device 120 and/or other communicatively coupled devices.

As shown in FIG. 1C, the head-wearable device 120, in response to receiving the user input to initiate the imaging device 123, activates (e.g., turns on or wakes) the imaging device 123 and illuminates the privacy protection unit 125 (e.g., an illuminated privacy indicator 127). The illuminated privacy indicator 127 notifies bystanders that the imaging device 123 is active and/or that an image capture is ongoing. In this way, bystanders can take appropriate measures to avoid being included in an image capture, prevent their (unwanted) inclusion in a captured image, and/or identify bad actors attempting to include them (or other objects) in a captured image. In some embodiments, the privacy protection unit 125 can be illuminated when other capture devices associated with the head-wearable device 120 are active. For example, the privacy protection unit 125 can also be illuminated when a microphone of the head-wearable device 120 is active. In some embodiments, the privacy protection unit 125 of the head-wearable device 120 is illuminated when a communicatively coupled device begins to capture image and/or audio data. For example, in accordance with a determination that the wrist-wearable device 110 (which is communicatively coupled with the head-wearable device 120) is capturing image data via a respective imaging device, the head-wearable device 120 can illuminate the privacy protection unit 125.

In FIG. 1D, the security guard 111 notices the illuminated privacy indicator 127 and notifies the user 105 of the restriction (e.g., “Excuse me, no photos”). The user 105, after hearing the security guard 111's warning, complies with the restriction and provides another touch input gesture 113 to disable the imaging device 123. When the user disables the imaging device 123, the head-wearable device 120 ceases to illuminate the privacy protection unit 125.

The user 105 waits around the exhibit 107 for another opportunity to capture an image of the exhibit 107. However, after waiting around for an extended period, the user 105 concludes that the security guard 111 will not be moving from its post (e.g., as shown in FIG. 1E, the user 105 thinks to herself, “I don't think he is going to leave”). As such, the user 105 decides to clandestinely capture an image of the exhibit 107.

In order to avoid being caught a second time, the user 105 attempts to conceal the privacy protection unit 125. Specifically, as shown in FIG. 1F, the user 105 covers the privacy protection unit 125 with a piece of paper or tape 130 in order to prevent bystanders from seeing the illuminated privacy indicator 127 when the imaging device 123 of the head-wearable device 120 is active.

As shown in FIGS. 1G and 1H, the user 105, after ensuring that the tape 130 covers the privacy protection unit 125, provides a touch input gesture 113 at the portion of the head-wearable device 120 to initiate the imaging device 123. The head-wearable device 120 initiates the imaging device 123 and illuminates the privacy protection unit 125; however, because the privacy protection unit 125 is covered by tape 130, the illuminated privacy indicator 127 is not visible.

As next shown in FIG. 1I, the user 105, after initiating the imaging device 123 of the head-wearable device 120, performs an additional user input to capture an image. For example, the user 105 performs a double-tap gesture 117 at the portion of the head-wearable device 120 to capture an image. However, because the user 105 concealed the privacy protection unit 125, the head-wearable device 120 will forgo capturing image data. The head-wearable device 120 determines that the user 105 concealed the privacy protection unit 125 by using sensor data obtained from the one or more sensors 215 (FIGS. 2A-2D) of the privacy protection unit 125 and image data obtained from the imaging device 123.

As an example, the head-wearable device 120 can use brightness data obtained by an ambient light sensor and brightness data obtained by the imaging device 123 (e.g., via an image sensor of the imaging device 123) to determine whether the user 105 tampered with, concealed, and/or obstructed the privacy indicator 220. In particular, the head-wearable device 120 compares a brightness ratio (e.g., a ratio of the brightness measured by ambient light sensor to the brightness measured by the imaging device 123) to a tamper threshold to determine whether the user 105 tampered with, concealed, and/or obstructed the privacy indicator 220. When the brightness ratio is less than or equal to the tamper threshold, the head-wearable device 120 determines that the user 105 tampered with the privacy indicator 220 and restricts use of the imaging device 123. Alternatively, when the brightness ratio is greater than the tamper threshold, the head-wearable device 120 determines that the user 105 has not tampered with the privacy indicator 220 and does not restrict use of the imaging device 123. Returning to FIG. 1I, as the user 105 covered the privacy protection unit 125, the brightness measured by the ambient light sensor is substantially zero and the brightness measured by the imaging device 123 is non-zero, resulting in a brightness ratio of approximately zero (e.g., substantially zero/non-zero). Because the brightness ratio in FIG. 1I is approximately zero, the head-wearable device 120 determines that the brightness ratio is less than a non-zero tamper threshold and restricts use of the imaging device 123.

In some embodiments, the tamper threshold is a predetermined ratio between the brightness measured by the ambient light sensor and the brightness measured by the imaging device 123. For example, in some embodiments, the tamper threshold is 50 percent, such that, if the brightness measured by the ambient light sensor is less than or equal to 50 percent of the brightness measured by the imaging device 123, tampering is detected. In some embodiments, the tamper threshold is selected based on the head-wearable device's environment (e.g., a dark environment or a bright environment). Specifically, if the head-wearable device 120 is in a dark environment, the head-wearable device 120 selects a dark environment tamper threshold (e.g., 60 percent, 70 percent). Alternatively, if the head-wearable device 120 is in a bright environment, the head-wearable device 120 selects a bright environment tamper threshold (e.g., 80 percent, 90 percent). The head-wearable device 120 determines whether it is in a dark environment or a bright environment based on a comparison of the brightness measured by the ambient light sensor with an (absolute) brightness threshold. For example, the brightness threshold can be 500 lux (the unit of illuminance), and when the head-wearable device 120 measures, via the ambient light sensor, brightness values above 500 lux, the head-wearable device 120 determines that the environment is bright and selects the bright environment tamper threshold. Alternatively, when the head-wearable device 120 measures, via the ambient light sensor, brightness values below 500 lux, the head-wearable device 120 determines that the environment is dark and selects the dark environment tamper threshold.

Additionally, or in the alternative, the head-wearable device 120 can use other sensors 215 of the privacy protection unit 125 to detect tampering with the privacy indicator 220. For example, the privacy protection unit 125 can include a proximity sensor and the head-wearable device 120 can determine that the privacy indicator 220 has been tampered with when an object (animate or inanimate) is detected to be on or within a predetermined distance of the privacy protection unit 125 (e.g., 2-5 cm). In some embodiments, the privacy protection unit 125 can include a capacitive sensor and the head-wearable device 120 can determine that the privacy indicator 220 has been tampered with when an animate object (e.g., a finger) is detected to be on or within a predetermined distance of the privacy protection unit 125. The above examples are non-limiting. Additional sensors included in the head-wearable device can be used to determine that a user 105 has tampered with the privacy indicator 220. Additional examples of tampering determinations are provided below in reference to FIGS. 2A-2D and 4-6.

FIG. 1J shows an example user interface presented to the user 105 via the display 935 of the head-wearable device 120. In some embodiments, the head-wearable device 120 presents an AR user interface (UI) to the user 105. The AR UI can be overlaid over the user 105's field of view in order to assist the user 105 in performing one or more operations using the head-wearable device 120 and/or a communicatively coupled device, and/or to provide additional information to the user. For example, when the user 105 initiates the imaging device 123, the head-wearable device 120 presents a camera AR UI 135 to the user 105 to assist the user 105 in capturing an image.

When the head-wearable device 120 detects the double-tap gesture 117 (shown in FIG. 11), the head-wearable device 120 determines that the privacy indicator 220 has been tampered with and/or concealed and restricts use of the imaging device 123. In conjunction with restricting use of the imaging device 123, in some embodiments, the head-wearable device 120 presents a notification to the user 105, via the camera AR UI 135, indicating that the imaging device is unavailable. The notification can include instructions or suggestions for removing the restriction or otherwise making the imaging device available. For example, in FIG. 1J, the camera AR UI 135 notifies the user that the camera is unavailable and provides the following suggestion: “Please clean front facing sensors and/or remove anything obstructing the front facing sensors.” Additionally or alternatively, in some embodiments, the user 105 can be notified that the imaging device 123 is unavailable via an audio output (e.g., an auditory notification), inward-facing light-emitting diode (LED) blinks, a companion mobile app notification, and/or a communicatively coupled device.

Turning to FIGS. 1K and 1L, the user 105 removes the tape 130 from the privacy protection unit 125. After the user 105 removes the tape 130, the illuminated privacy indicator 127 becomes visible and the head-wearable device 120 determines that the privacy indicator 220 is no longer tampered with and/or concealed. As a result, the head-wearable device 120 removes the restrictions on the imaging device 123 (e.g., allows the user 105 to capture image data using the imaging device 123).

In FIGS. 1M and 1N, the user 105 waits for an opportunity to capture an image of the exhibit 107 without being discovered and performs another user input to capture an image. Specifically, the user 105, when she believes herself to be in the clear, performs a double-tap gesture 117 at the portion of the head-wearable device 120 to capture an image. Responsive to the double-tap gesture 117, the head-wearable device 120 captures an image of the exhibit 107. The camera AR UI 135 presented to the user 105 by the display 935 of the head-wearable device 120 informs the user 105 of the successful capture. Unfortunately for the user 105, the security guard 111 notices the user 105 capturing the image and ejects the user 105 from the museum.

FIGS. 2A-2D illustrate example head-wearable devices, in accordance with some embodiments. FIG. 2A shows a first embodiment of a head-wearable device 205; FIG. 2C shows a second embodiment of a head-wearable device 207; and FIG. 2D shows a third embodiment of a head-wearable device 209. The first, second, and third embodiments of the head-wearable devices 205, 207, and 209 are instances of the head-wearable device 120 shown and described above in reference to FIGS. 1A-1N. Additionally, first, second, and third embodiments of the head-wearable devices 205, 207, and 209 are instances of the head-wearable device shown and described below in reference to FIGS. 9A-9C. Thus, the first, second, and third embodiments of the head-wearable devices 205, 207, and 209 should be understood to have the features of the head-wearable device 120, AR devices 900, and/or the VR devices 910, and vice versa.

The first embodiment of the head-wearable device 205 includes at least an imaging device 123 and a privacy protection unit 125. The privacy protection unit 125 includes at least a privacy indicator 220 and one or more sensors 215. The privacy protection unit 125 can be disposed on a first frame portion 211 of the first embodiment of the head-wearable device 205 (e.g., an exterior-facing left-side portion of the head-wearable device 205), and the imaging device 123 can be disposed on a second frame portion 213 of the first embodiment of the head-wearable device 205 (e.g., an exterior-facing right-side portion of the head-wearable device 205) opposite the first frame portion 211.

The privacy indicator 220 can be an LED and/or other type of illumination source. The privacy indicator 220 is associated with the imaging device 123 such that, when the imaging device 123 is activated, the privacy indicator 220 is illuminated. The privacy indicator 220 can be illuminated such that it generates a light ring around a perimeter of the privacy protection unit 125. Alternatively, in some embodiments, the privacy indicator 220 is a stationary light. The privacy indicator 220 can be illuminated in one or more colors (e.g., blue, green, red, white), one or more patterns (blinking patterns, error codes, etc.), and/or one or more intensities. The one or more sensors 215 are configured to obtain data that is used for determining whether the privacy indicator 220 is obstructed, concealed, and/or tampered with. The types of sensors and data collected are described below in reference to FIG. 2B.

The imaging device 123 can be any type of camera, such as an ultra-wide-angle camera, a red-green-blue (RGB) camera, a wide-angle camera, a fish-eye camera, a spherical camera, a telephoto camera, a depth-sensing camera, or another type of camera. In some embodiments, a head-wearable device can include more than one imaging device 123.

Turning to FIG. 2B, an example privacy protection unit 125 is shown. The privacy protection unit 125 can be formed of a cover window 230 (or cover glass), tint 235, one or more waveguides 249 (e.g., light pipes), one or more sensors 215, and/or one or more privacy indicators 220. In some embodiments, the privacy protection unit 125 includes more or fewer components than described above.

The one or more sensors 215 can include one or more ambient light sensors, proximity sensors, infrared sensors, capacitive sensors, Hall effect sensors, etc. The one or more sensors 215 detect changes and/or measure conditions in an external environment. For example, an ambient light sensor can measure an amount of light in an environment of the head-wearable device. The light measured by the ambient light sensor can be compared to an amount of light detected by the imaging device 123 to determine whether a user has tampered with the privacy indicators 220 (e.g., a ratio of the light measured by the ambient light sensor to the light measured by the imaging device 123 is above or below a tamper threshold, as described herein). Alternatively or in addition, a proximity sensor can detect the presence of an object (animate and/or inanimate) on or in proximity to the privacy protection unit 125, such that when the object is within a predetermined distance of the privacy protection unit 125 the head-wearable device 120 determines that a user has tampered with the privacy indicators 220. In some embodiments, a capacitive sensor can detect an animate object (e.g., a finger) on or in proximity to the privacy protection unit 125, such that when the animate object is within a predetermined distance of the privacy protection unit 125 the head-wearable device 120 determines that a user has tampered with the privacy indicators 220. The above examples are non-limiting and additional sensor data can be used to determine whether a tamper threshold has been satisfied.

As described above, the one or more privacy indicators 220 are illuminated in accordance with a determination that the imaging device 123 is active. Light generated by the one or more privacy indicators 220 travels through the one or more waveguides 249, the tint 235, and the cover window 230 as it is directed outward (e.g., toward bystanders).

The second embodiment of the head-wearable device 207 includes an imaging device with an integrated privacy protection unit-a privacy protective imaging device 240. The privacy protective imaging device 240 can be disposed on a first frame portion 211 (e.g., an exterior-facing left-side portion) or a second frame portion 213 (e.g., an exterior-facing right-side portion) of the second embodiment of the head-wearable device 207. In some embodiments, the second embodiment of the head-wearable device 207 includes the privacy protection unit 125, which can be disposed opposite the privacy protective imaging device 240 (e.g., the first frame portion 211 or the second frame portion 213).

The privacy protective imaging device 240 includes an integrated imaging device 245, one or more privacy indicators 220, and/or one or more sensors 215. In some embodiments, an exterior perimeter of the privacy protective imaging device 240 is illuminated when the integrated imaging device 245 is active. In some embodiments, the integrated imaging device 245 and the one or more sensors 215 are disposed between the one or more privacy indicators 220. Alternatively, in some embodiments, the integrated imaging device 245 is disposed between the one or more privacy indicators 220 and the one or more sensors 215 are disposed adjacent to the exterior perimeter of the privacy protective imaging device 240.

As shown in FIG. 2C, in some embodiments, the privacy protective imaging device 240 is formed by a cover window 230 (or cover glass), one or more privacy indicators 220, one or more waveguides 249 (e.g., light pipes), the integrated imaging device 245, and one or more lens drives 247 (e.g., for controlling the integrated imaging device 245). The integrated imaging device 245 is formed of an imaging device lens 244 and an image sensor 243. The integrated imaging device 245 has an imaging device field of view 251 (e.g., an area visible by the integrated imaging device 245 can be captured in image data).

In some embodiments, the privacy protective imaging device 240 includes two lens drives 247a and 247b, two waveguides 249a and 249b, and two privacy indicators 220a and 220b. The two lens drives 247a and 247b are disposed at an outer perimeter of the privacy protective imaging device 240 and spaced apart by the length of the cover window 230. The two waveguides 249a and 249b are disposed adjacent to the lens drives 247. For example, a first waveguide 249a is disposed adjacent to a first lens drive 247a and a second waveguide 249b is disposed adjacent to a second lens drive 247b. The two privacy indicators 220a and 220b are disposed between the two lens drives 247a and 247b and the two waveguides 249a and 249b. For example, a first privacy indicator 220a is disposed between the first lens drive 247a and the first waveguide 249a and a second privacy indicator 220a is disposed between the second lens drive 247b and the second waveguide 249b. Light generated by the two privacy indicators 220a and 220b is directed toward the two waveguides 249a and 249b and redirected outside of the frame of the head-wearable device (e.g., such that the light is visible by bystanders).

The privacy protective imaging device 240 is configured to crop a portion of the imaging device field of view 251. In particular, light generated by the one or more privacy indicators 220 and redirected by the one or more waveguides forms light edges at, within, or outside of the perimeter of the privacy protective imaging device 240. The light edges partially crop the imaging device field of view 251 and form a cropped field of view 253. The imaging device field of view 251 and the cropped field of view 253 form an image circle (e.g., the space between the imaging device field of view 251 and the cropped field of view 253). The image circle is used to detect attempts to obstruct, conceal, and/or tamper with the illuminated privacy indicators 220. Specifically, the head-wearable device detects blockage artifacts within the image circle and disables the imaging device 245 until the blockage artifacts are removed.

The third embodiment of the head-wearable device 209 includes the privacy protective imaging device 240 and a privacy indicator strip 255. In some embodiments, the third embodiment of the head-wearable device 209 can include a privacy protection unit 125 as described above in reference to FIGS. 2A-2C. The privacy indicator strip 255 can be an extension of the privacy protective imaging device 240. More specifically, the privacy indicator strip 255 can be illuminated in conjunction with the privacy indicators 220 when the integrated imaging device 245 is active. In some embodiments, the privacy indicators 220 and the privacy indicator strip 255 form a continuous light pattern. Specifically, the privacy indicators 220 can form a light ring around the perimeter of the privacy protective imaging device 240 and the privacy indicator strip 255 can form a connected light strip or light tail that connects with the light ring and travels along a portion of a temple arm of the third embodiment of a head-wearable device 209.

The privacy indicator strip 255 is an additional indicator that illuminates an area adjacent to an imaging device. As the privacy indicator strip 255 does not directly face a person being photographed and looking at a user's face (who is wearing the head-wearable device), the person being photographed has a reduced sense of intimidation (e.g., she does not have a front-facing light (or ring of light) directly pointed at her (when the imaging device is active)). By illuminating a portion of a temple arm of the head-wearable device (e.g., a side-facing or non-front-facing portion of the head-wearable device), persons being photographed no longer receive the full intensity of the privacy indicators 220. For example, the person being photographed may only receive 70 percent of the intensity of the light, thus diminishing the intimidation factor as the light is not entirely focused on the (front-facing) person being photographed. Additionally, the privacy indicator strip 255 also alerts bystanders next to and around a user wearing the head-wearable device when an imaging device is active.

The position of the privacy indicators, the imaging device, and the one or more sensors in the second and third embodiments of the head-wearable devices 207 and 209 provide additional tamper-preventive safeguards. Specifically, as the devices are generally disposed at the same frame portion, covering the privacy indicators may not be possible without covering the imaging device. Additionally, because of the position of the privacy indicators and the imaging device, performing the detection method described above in reference to FIGS. 1A-1N may not be required, which simplifies the system.

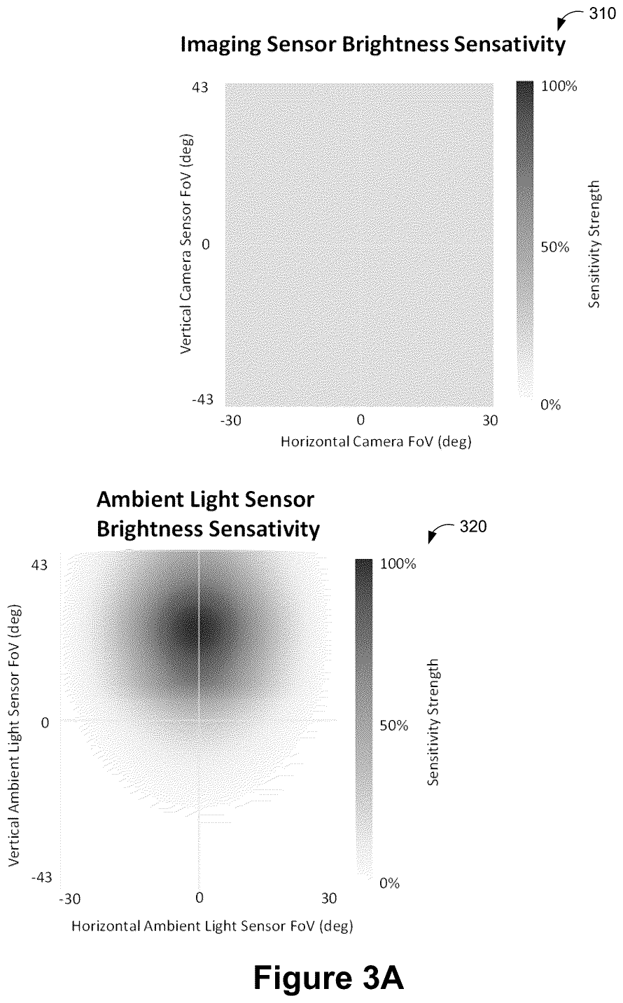

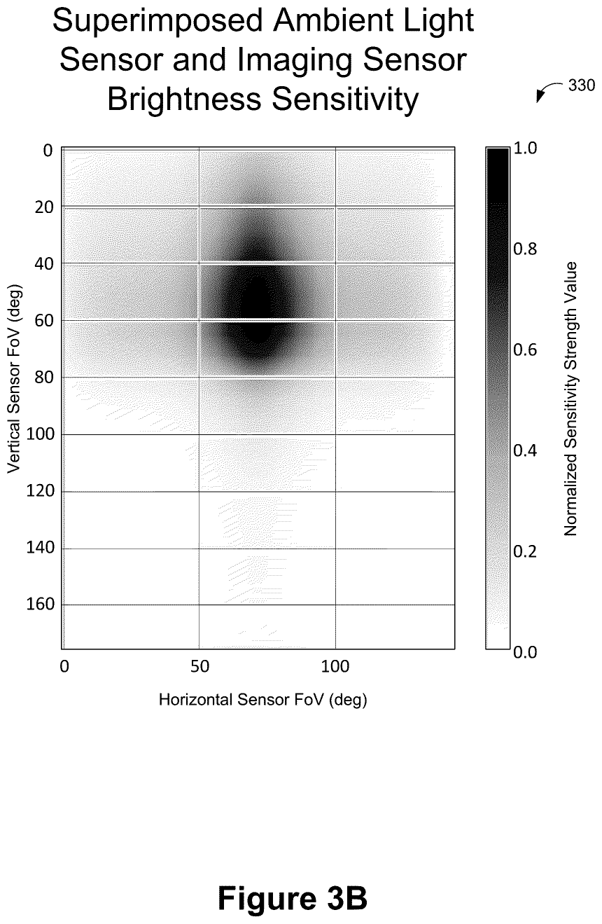

Additionally, as the imaging device and the one or more sensors are generally disposed at the same frame portion, the second and third embodiments of the head-wearable device 207 and 209 do not rely on field-of-view matching as described below in reference to FIGS. 3A and 3B. Additionally, variable field-of-view changes due to varying head sizes are not as significant in the second and third embodiments of the head-wearable devices 207 and 209.

FIGS. 3A-3B illustrate sensor data and image data used by an example bystander capture privacy protection system, in accordance with some embodiments. In some embodiments, the example bystander capture privacy protection method can include performance of one or more operations for optimizing detection of privacy indicator 220 tampering, concealment, and/or obstruction. Optimization can be achieved by matching fields of view of a sensor 215, such as an ambient light sensor, and an imaging device 123 (FIGS. 1A-2D), as discussed below. Optimization also includes reducing the number of false positives detected by the head-wearable device 120. A false positive can occur when a portion of a scene viewed by the user 105 is significantly darker than another portion of the scene, which falsely indicates that the bystander capture privacy protection system is being tampered with.

Turning to FIG. 3A, in some embodiments, to increase the accuracy of the tamper-detection methods described herein, a field of view of a sensor 215 and a field of view of an imaging device 123 are matched. Specifically, the head-wearable device 120 can detect a difference between the field of view of the sensor 215 and the field of view of the imaging device 123 and match the field of views based on the difference. The field-of-view differences can be based on the type of sensors used, the type of imaging device used, the position of the sensors, the position of the imaging device, and/or other factors. For example, as shown in chart 320 illustrated in FIG. 3A, an ambient light sensor (e.g., sensor 215) can have an increased light sensitivity in an upper-center portion of an image frame, whereas, as shown in chart 310, the imaging device 123 can detect uniform brightness across an image frame. The differences between the ambient light sensor and the imaging device can be used to match the fields of view of the devices.

In order to match the fields of view of the sensors, field of view data of the sensor and field of view data of the imaging sensor are captured, which include respective vertical and horizonal field of views (e.g., a vertical field of view of 86 degrees and a horizontal field of view of 60 degrees). The field of view data is interpolated and resampled at a definition of a preview frame. In some embodiments, the preview frame includes a predetermined preview frame size (e.g., 320×240, 176×144). Row and column vectors and a 2D matrix are created. Ambient light sensor sensitivity is normalized by setting the area under curbe the 2D matrix to 1. Brightness data captured by the imaging sensor is scaled by having an area under its 2D matrix equal to 1. The normalized and scaled ambient light sensor sensitivity and the scaled brightness data are used to generate the sensitivity maps shown in FIG. 3A.

The resulting sensitivity maps (e.g., chart 310 and chart 320) are used to determine a corrected lux for the imaging sensor. In particular, the corrected lux for the imaging sensor is determined by a scaling factor of the ambient light sensor and camera sensitivity ratio. For example, the corrected lux for the imaging sensor can be equal to a lux of an imaging sensor (e.g., camera) multiplied by (i) a width, (ii) a height, and (iii) a ratio of (a) a double summation of a luma (from YUV) multiplied by a sensitivity of the sensor over (b) a double summation of a luma (from YUV), where the summation is across the height and the width.

FIG. 3B illustrates a field of view matching sensitivity map of the sensor data and image data such that the image data and sensor data are lined up and overlayed on the same graph. An example scenario that can create a false positive includes a dark environment illuminated with overhead lights such that, a top half of a scene viewed by the user 105 is darker than the bottom half of the scene. The contrasting brightness between the top half and the bottom half of the scene can trigger a false positive indicating that a privacy indicator 220 has been tampered with, when in fact the privacy indicator 220 had not been modified. As discussed with respect to FIG. 3A, to reduce the number of false positives, the system can: (i) check the alignment of the vertical and horizontal axes' of the imaging device and the ambient light sensor, and (ii) check the vertical and horizontal field of view and the ambient light sensor. The example data illustrated in FIG. 3B shows the field of views of the ambient light sensor sensitivity data matched with an image data frame, where “1” represents the highest sensitivity and “0” the lowest. In the plot shown in FIG. 3B, X and Y axes represent vertical and horizontal field of view in degrees of image data frame. By matching the fields of view of the sensors 215 and the imaging device 123, the bystander capture privacy protection method improves the accuracy in situations where the brightness in a scene (e.g., an image frame or environment) is not uniformly distributed by normalizing the sensor and image data.

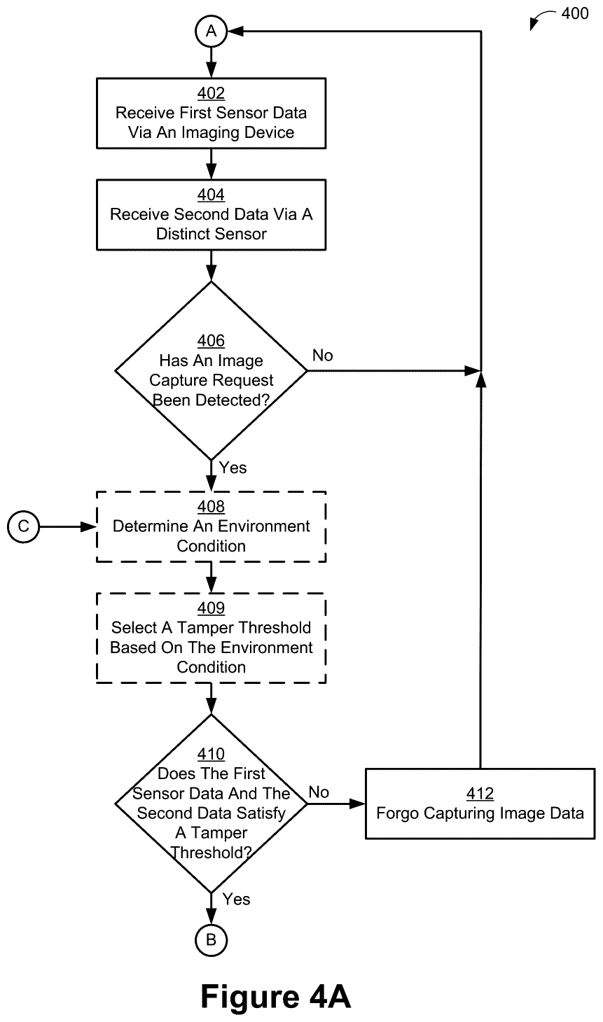

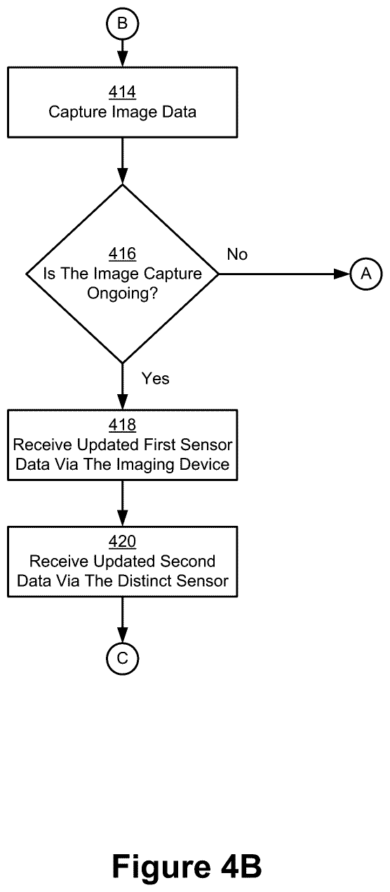

FIGS. 4A-6 illustrate flow diagrams of methods for bystander capture privacy protection, in accordance with some embodiments. Operations (e.g., steps) of the methods 400, 500, and 600 can be performed by one or more processors (e.g., central processing unit and/or MCU) of a system (e.g., a head-wearable device 120, an AR device 900, and/or virtual-reality device 900; FIGS. 1A-2D and FIGS. 9A-9C). At least some of the operations shown in FIGS. 4A-6 correspond to instructions stored in a computer memory or a computer-readable storage medium (e.g., storage, RAM, and/or memory 950; FIG. 9C). Operations of the methods 400, 500, and 600 can be performed by a single device alone or in conjunction with one or more processors and/or hardware components of another communicatively coupled device (e.g., a wrist-wearable device 800, a handheld intermediary processing device 1000, a server 730, a computer 740, a mobile device 750; FIGS. 7A and 7B) and/or instructions stored in memory or a computer-readable medium of the other communicatively coupled device.

Methods 400, 500, and 600 provide operations for protecting bystanders' privacy by restricting use of an imaging device when a privacy indicator is determined to be tampered with or concealed. Specifically, the methods 400, 500, and 600 are configured to detect tampering with or concealment of a privacy indicator that is i) associated with an imaging device and ii) configured to notify bystanders that the imaging device is active. The privacy indicator is illuminated when the imaging device is turned on and/or while the imaging device is active and attempts to conceal or tamper with the privacy indicator, causing the imaging device to be (temporarily) disabled. The privacy indicator and the imaging device can be part of the same device (e.g., a head-wearable device 120 including a privacy indicator 220 and an imaging device 123) or distinct devices (e.g., a head-wearable device 120 including the privacy indicator 220, and a wrist-wearable device 800 including an imaging device). By preventing users from tampering with or concealing the privacy indicator, bystanders in proximity to the user can determine when an imaging device is active and take appropriate measures to identify bad actors or avoid being inadvertently captured in an image.

In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device but should not be construed as limiting the performance of the operation to the particular device in all embodiments.

Turning to FIGS. 4A-4B, the method 400 is performed at a head-wearable device worn by a user and including an imaging device, one or more sensors, and a privacy indicator. The method 400 includes receiving (402) first sensor data via the imaging device and receiving (404) second data via a distinct sensor of the one or more sensors. The distinct sensor can be an ambient light sensor, a capacitive sensor, a proximity sensor, an infrared sensor, a Hall effect sensor, etc. In some embodiments, sensor data from more than one sensor is received. For example, the method 400 can include receiving sensor data via an ambient light sensor and a proximity data, and the sensor data of each sensor can be used individually or in combination with the sensor data from the imaging device to determine whether the use has tampered with or concealed the privacy indicator, as discussed below.

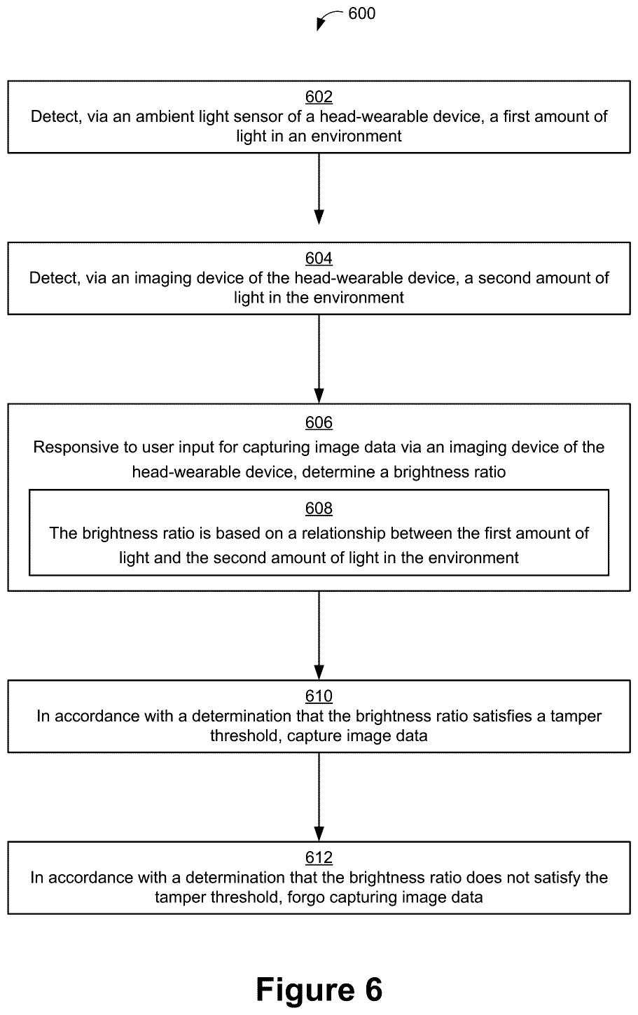

The method 400 includes determining (406) whether an image capture request has been detected. The image capture request can include a request to record a video, audio, and/or a still image. The image capture request can be provided via a user input at the head-wearable device 120 and/or a communicatively coupled device (e.g., a wrist-wearable device 800, a handheld intermediary processing device 900; FIGS. 6A and 6B). For example, the user input can be a hand gesture detected by the head-wearable device 120, the wrist-wearable device 800, and/or the handheld intermediary processing device 900. Alternatively, or in addition, in some embodiments the image capture request can be detected when an image capture trigger condition is satisfied. For example, an image capture trigger condition can include a minimum speed threshold such that when the user meets or exceeds the minimum speed threshold, the image capture trigger condition is satisfied and the image capture request is detected. In some embodiments, the image capture request can be provided via a voice command and/or touch command at the head-wearable device 120 and/or the communicatively coupled device.

In accordance with a determination that an image capture request has not been detected (“No” at operation 406), the method 400 returns to operation 402.

Alternatively, in accordance with a determination that an image capture request has been detected (“Yes” at operation 406), the method 400 can include determining (408) an environmental condition. For example, the method 400 can determine whether the head-wearable device 120 is in a dark environment (e.g., in a shaded area, in a poorly lit room, etc.) or in a bright environment (e.g., outside on a sunny day, in a well-lit room). In some embodiments, the method 400 determines the environmental condition based on the second data received via the distinct sensor. For example, the second data can be brightness data measured by an ambient light sensor and, in accordance with a determination that the brightness data meets or exceeds a brightness threshold, the method 400 can determine that the environmental condition is a bright environment. Alternatively, in accordance with a determination that the brightness data does not meet or exceed the brightness threshold, the method 400 can determine that the environmental condition is a dark environment.

In some embodiments, the method 400 includes selecting a tamper threshold based on the environmental condition. For example, in accordance with a determination that the head-wearable device 120 is in a bright environment, the method 400 selects a bright environment tamper threshold. Alternatively, in accordance with a determination that the head-wearable device 120 is in a dark environment, the method 400 selects a dark environment tamper threshold.

The method 400 further includes determining (410) whether the first sensor data and the second data satisfy a tamper threshold. Specifically, the method 400 includes determining whether a ratio of the second to first sensor data (e.g., second data, first data) satisfies the tamper threshold. The tamper threshold is a predetermined ratio between the sensor data of the imaging device and the distinct sensor. For example, the tamper threshold can be a ratio of 40 percent of the second data to the first data (e.g., the second data must be at least 40 percent of the first sensor data). As described above, the tamper threshold can be selected based on the type of environment. For example, in a bright environment, a bright environment tamper threshold can be larger (e.g., a ratio of at least 80 percent, 90 percent), as it can be assumed that there would be less shade or other obstructions. Alternatively, in a dark environment, a dark environment tamper threshold can be smaller (e.g., a ratio of at least 60 percent, 70 percent) as it can be assumed that there would be more shade or dark areas. In some embodiments, the tamper threshold is dynamically adjusted based on environmental conditions or changes in an environment (e.g., moving from indoors to outdoors, moving clouds creating shade).

The method 400, in accordance with a determination that the ratio of the second to first sensor data does not satisfy the tamper threshold (“No” at operation 410), the method 400 includes forgoing (412) capturing image data and returning to operation 402. The tamper threshold is determined not to be satisfied when the ratio of the second to first sensor data is less than the tamper threshold. For example, the tamper threshold can be 60 percent, the first data can be a measured brightness of 300 lux, and the second data can be a measured brightness of 100 lux, which results in a ratio of the second sensor data to first sensor data of 30 percent (e.g.,

$$\frac{100 lux}{300 lux} \times 100 ) ,$$

and the tamper threshold not being satisfied (e.g., 30 percent is less than 60 percent). Examples of restricting the use of the imaging device are provided above in reference to FIGS. 1A-1N.

Alternatively, the method 400 includes, in accordance with a determination that the first sensor data and the second data do satisfy the tamper threshold (“Yes” at operation 410), capturing (414) image data. For example, the tamper threshold can be 80 percent, the first data can be a measured brightness of 400 lux, and the second data can be a measured brightness of 360 lux, which results in a ratio of the second sensor data to first sensor data of 90 percent (e.g.,

$$\frac{360 lux}{400 lux} \times 100 ) ,$$

and the tamper threshold being satisfied (e.g., 90 percent is greater than 80 percent). Examples of the head-wearable device 120 capturing an image are provided above in reference to FIGS. 1A-1N.

The method 400 further includes determining (416) whether the image capture is ongoing. The method 400 includes, in accordance with a determination that the image capture is not ongoing (“No” at operation 416), the method 400 returns to operation 402. Alternatively, the method 400 includes, in accordance with a determination that the image capture is ongoing (“Yes” at operation 416), receiving (418) updated first sensor data via the imaging device and receiving (420) updated second data via the distinct sensor. The method 400 further returns to operation 408.

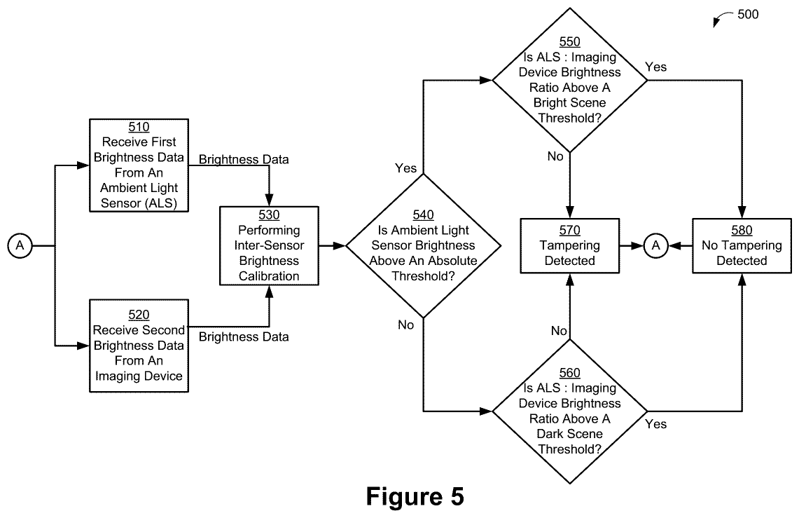

In FIG. 5, the method 500 is performed at a head-wearable device 120 worn by a user and including an imaging device 123, one or more ambient light sensors (e.g., sensors 215; FIGS. 2A-2D), and a privacy indicator 220 (FIGS. 2A-2D). The method 500 includes receiving (510) first brightness data from an ambient light sensor and receiving (520) second brightness data from the imaging device of the head-wearable device 120. The method further includes performing (530) inter-sensor brightness calibration. In some embodiments, the inter-sensor brightness calibration includes calibrating and translating one sensor's brightness unit to another sensor's brightness unit. For example, the ambient light sensors' brightness unit can be calibrated and translated to the imaging device, and/or vice versa.

The method 500 further includes determining (540) whether the first brightness data received from the ambient light sensor satisfies an (absolute) brightness threshold. The (absolute) brightness threshold can be used to determine whether an environment is bright or dark. For example, when the (absolute) brightness threshold is not satisfied, the environment is determined to be dark. Alternatively, when the (absolute) brightness threshold is satisfied, the environment is determined to be bright. The (absolute) brightness threshold can be a predetermined value for a particular environment. For example, a bedroom can have an average brightness threshold of 50-150 lux, an office can have an average brightness threshold of 300-500 lux, full daylight outside can have an approximate brightness threshold of 10,000 lux, an overcast day can have an approximate brightness threshold of 1,000 lux, etc. In some embodiments, the user's location can be used to define the (absolute) brightness threshold. For example, the user can be at school and the (absolute) brightness threshold can be set to a classroom-specific brightness threshold. Alternatively, in some embodiments, the user can define her location such that the head-wearable device 120 can select the corresponding (absolute) brightness threshold.

The method 500 includes, in accordance with a determination that the first brightness data received from the ambient light sensor does satisfy the (absolute) brightness threshold (“Yes” at operation 540), determining (550) whether a ratio of the first brightness data received from the ambient light sensor to the second brightness data received from the imaging device is above a bright scene threshold (also referred to as the bright environment tamper threshold; FIGS. 4A and 4B). In other words, the user's environment is determined to be bright, and a bright environment tamper threshold is used to determine whether the privacy indicator has been tampered with and/or concealed. Satisfaction of the bright environment tamper threshold is discussed in detail above in reference to FIGS. 4A and 4B.

The method 500 includes, in accordance with a determination that the ratio of the first brightness data received from the ambient light sensor to the second brightness data received from the imaging device is not above the bright scene threshold (“No” at operation 550), determining (570) that tampering is detected (and disabling the imaging device, as described above in reference to FIGS. 1A-2D, 4A, and 4B). The method 500 further includes returning to operations 510 and 520.

Alternatively, the method 500 includes, in accordance with a determination that the ratio of the first brightness data received from the ambient light sensor to the second brightness data received from the imaging device is above the bright scene threshold (“Yes” at operation 550), determining (580) that no tampering was detected (and allowing the user to capture image data, as described above in reference to FIGS. 1A-2D, 4A, and 4B). The method 500 further includes returning to operations 510 and 520.

The method 500 includes, in accordance with a determination that the first brightness data received from the ambient light sensor does not satisfy the (absolute) brightness threshold (“No” at operation 540), determining (550) whether a ratio of the first brightness data received from the ambient light sensor to the second brightness data received from the imaging device is above a dark scene threshold (also referred to as the dark environment tamper threshold; FIGS. 4A and 4B). In other words, the user's environment is determined to be dark, and a dark environment tamper threshold is used to determine whether the privacy indicator has been tampered with and/or concealed. Satisfaction of the dark environment tamper threshold is discussed in detail above in reference to FIGS. 4A and 4B.

The method 500 includes, in accordance with a determination that the ratio of the first brightness data received from the ambient light sensor to the second brightness data received from the imaging device is not above the dark scene threshold (“No” at operation 560), determining (570) that tampering is detected (and disabling the imaging device, as described above in reference to FIGS. 1A-2D, 4A, and 4B). The method 500 further includes returning to operations 510 and 520.

Alternatively, the method 500 includes, in accordance with a determination that the ratio of the first brightness data received from the ambient light sensor to the second brightness data received from the imaging device is above the dark scene threshold (“Yes” at operation 560), determining (580) that no tampering was detected (and allowing the user to capture image data, as described above in reference to FIGS. 1A-2D, 4A, and 4B). The method 500 further includes returning to operations 510 and 520.

Although the above example describes two environments (e.g., dark and bright), in some embodiments the method 500 can distinguish between more than two environments and select an appropriate tamper threshold based on the environment. For example, in some embodiments, the method 500 can determine that the environment is indoors, outdoors, in a classroom, in an office, etc.

(A1) FIG. 6 shows a flow chart of the method 600 for privacy-indicator tamper detection, in accordance with some embodiments. The method 600 is performed at the head-wearable device 120 worn by a user and including an imaging device 123, one or more ambient light sensors (e.g., sensors 215; FIGS. 2A-2D), and a privacy indicator 220 (FIGS. 2A-2D). The method 600 includes detecting (602), via an ambient light sensor of the head-wearable device 120, a first amount of light in an environment, and detecting (604), via the imaging device of the head-wearable device, a second amount of light in the environment. For example, as described above in reference to FIGS. 1A-5, the one or more sensors 215 of the head-wearable device 120 and the imaging device 123 can measure brightness in an environment.

The method 600 includes, responsive to a user input for capturing image data via the imaging device of the head-wearable device, determining (606) a brightness ratio. The brightness ratio is based on a relationship between the first amount of light and the second amount of light in the environment (608). For example, as described above in reference to FIGS. 1A-5, the brightness ratio can be a ratio of the brightness measured by an ambient light sensor to the brightness measured by an imaging device.

The method 600 includes, in accordance with a determination that the brightness ratio satisfies a tamper threshold, capturing (610) image data. The method 600 further includes, in accordance with a determination that the brightness ratio does not satisfy the tamper threshold, forgoing (612) capturing image data. Examples of capturing and forgoing the capture of data are provided above in reference to FIGS. 1A-5.

(A2) In some embodiments of A1, the tamper threshold is a first tamper threshold or a second tamper threshold, and the method 600 includes, before determining whether the brightness ratio satisfies the tamper threshold, determining whether the first amount of light in the environment satisfies a brightness threshold. The method 600 includes, in accordance with a determination that the first amount of light in the environment satisfies the brightness threshold, using the first tamper threshold as the tamper threshold. The method 600 further includes, in accordance with a determination that the first amount of light in the environment does not satisfy the brightness threshold, using the second tamper threshold as the tamper threshold.

(A3) In some embodiments of A1-A2, the method 600 further includes, prior to detecting the first amount of light and the second amount of light in the environment, calibrating the ambient light sensor and the imaging device.

(A4) In some embodiments of A1-A3, the method 600 includes, before determining the brightness ratio, determining, for the ambient light sensor of the head-wearable device, a first field of view, and determining, for the imaging device of the head-wearable device, a second field of view. The method 600 further includes, based on a comparison of the first field of view and the second field of view, selecting a matching field of view. The determination of the brightness ratio is based on the relationship between the first amount of light and the second amount of light within the matching field of view. Examples of the field-of-view matching are described above in reference to FIGS. 3A and 3B.

(A5) In some embodiments of A1-A4, the method 600 includes, before determining the brightness ratio, in accordance with a determination, based on a comparison of the first amount of light and the second amount of light, that respective amounts of lights detected by the ambient light sensor and the imaging device are not uniformly distributed within respective fields of view of the ambient light sensor and the imaging device, i) superimposing a portion of the first amount of light on the second amount of light, and ii) updating the second amount of light to include the portion of the first amount of light superimposed on the second amount of light. Examples of superimposing the sensor sensitivity are described above in reference to FIGS. 3A and 3B.

(A6) In some embodiments of A1-A5, the method 600 includes, while the imaging device of the head-wearable device is capturing image data, detecting, via the ambient light sensor of the head-wearable device, a third amount of light in the environment, and detecting, via the imaging device of the head-wearable device, a fourth amount of light in the environment. The method 600 further includes determining another brightness ratio, which is based on a relationship between the third amount of light and the fourth amount of light in the environment. The method 600 also includes, in accordance with a determination that the other brightness ratio satisfies a tamper threshold, continuing to capture image data; and, in accordance with a determination that the other brightness ratio does not satisfy the tamper threshold, ceasing capturing image data. In other words, as described above in reference to FIGS. 4A-5, the method 600 operations can be continuously performed.

(A7) In some embodiments of A1-A6, the first amount of light and the second amount of light in the environment are detected in response to receiving a user input for capturing image data via the imaging device of the head-wearable device.

(A8) In some embodiments of A1-A7, the method 600 further includes, in accordance with the determination that the brightness ratio does not satisfy the tamper threshold, providing a notification to a user of the head-wearable device. The notification includes suggestions for satisfying the tamper threshold. For example, as shown and described above in reference to FIGS. 1A-1N, the head-wearable device 120 can cause the presentation of an AR UI that includes a status of an imaging device. In some embodiments, the notification is an auditory notification, haptic notification, and/or visual notification.

(A9) In some embodiments of A1-A8, the method 600 includes detecting, via a proximity sensor of the head-wearable device, presence of an object in proximity to a portion of the head-wearable device. The method 600 includes, responsive to the user input for capturing image data via the imaging device of the head-wearable device, i) in accordance with a determination that the object in proximity to the portion of the head-wearable device is within a predetermined tamper distance threshold, forgoing capturing image data; and ii) in accordance with a determination that the object in proximity to the portion of the head-wearable device is not within a predetermined tamper distance threshold, capturing the image data.

(A9.5) In some embodiments of A1-A8, the method 600 includes determining a vertical and horizontal axes of the field of view of the ambient light sensor (e.g., chart 320), determining a vertical and horizontal axes of the field of view of the imaging device (e.g., chart 310), and matching the vertical and horizontal axes of the ambient light sensor and imaging device (e.g., chart 330). As described in FIGS. 3A-3B, sensitivity maps based on data captured by an ambient light sensor and imaging device 123 are used to detect and reduce false positives.

(A10) In some embodiments of A1-A9, the method 600 includes detecting, via a capacitance sensor of the head-wearable device, a capacitance value at a portion of the head-wearable device. The method 600 further includes, responsive to the user input for capturing image data via the imaging device of the head-wearable device, i) in accordance with a determination that the capacitance value is within a predetermined tamper capacitance threshold, forgoing capturing image data; and ii) in accordance with a determination that the capacitance value is not within the predetermined tamper capacitance threshold, capturing the image data.

(A11) In some embodiments of A1-A10, the head-wearable device includes a privacy indicator adjacent to the ambient light sensor of the head-wearable device.

(A12) In some embodiments of A11, the privacy indicator and the ambient light sensor are disposed on a first frame portion of the head-wearable device and the imaging device is disposed on a second frame portion of the head-wearable device, opposite the first frame portion of the head-wearable device. For example, as shown in FIGS. 1A-2A, the privacy indicator and the ambient light sensor can be included in a privacy protection unit 125 disposed on a first frame portion of the head-wearable device 120.

(A13) In some embodiments of A11, the privacy indicator, the ambient light sensor, and the imaging device are disposed on the same frame portion of the head-wearable device. For example, as shown in FIGS. 2C and 2D, the privacy indicator, the ambient light sensor, and the imaging device can be included housed at a single location (e.g., a privacy protective imaging device 240).

(B1) In accordance with some embodiments, a system includes one or more of a wrist-wearable device, a head-wearable device, and/or a handheld intermediary processing device, and the system is configured to perform operations corresponding to any of A1-A12.

(C1) In accordance with some embodiments, a non-transitory computer-readable storage medium including instructions that, when executed by a computing device in communication with a wrist-wearable device, a head-wearable device, and/or a handheld intermediary processing device, cause the computer device to perform operations corresponding to any of A1-A12.

(D1) In accordance with some embodiments, a means on a wrist-wearable device, a head-wearable device, and/or a handheld intermediary processing device for performing or causing performance of the method of any of A1-A12.

(E1) In accordance with some embodiments, a head-wearable device includes an ambient light sensor, an imaging device, a privacy indicator, and one or more programs. The one or more programs are stored in memory and configured to be executed by one or more processors. The one or more programs include instructions for performing the operations of the method of any of A1-A12.

(E2) In some embodiments of E1, the imaging device is disposed on a first frame portion of the head-wearable device, and the ambient light sensor and the privacy indicator are disposed on a second frame portion, opposite the first frame portion, of the head-wearable device.

(E3) In some embodiments of E1, the ambient light sensor, the imaging device, and the privacy indicator are disposed on a first frame portion of the head-wearable device. The privacy indicator is configured to illuminate a perimeter of the first frame portion of the head-wearable device that outlines the ambient light sensor and/or the imaging device.

(E4) In some embodiments of E1, the ambient light sensor, the imaging device, and the privacy indicator are disposed on a first frame portion of the head-wearable device. The privacy indicator is configured to illuminate i) a perimeter of the first frame portion of the head-wearable device that outlines the ambient light sensor and/or the imaging device, ii) a third frame portion, adjacent to the first frame portion, of the head-wearable device, and iii) a temple arm portion adjacent to the third frame portion.

The devices described above are further detailed below, including systems, wrist-wearable devices, headset devices, and handheld intermediary processing devices. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 800, a head-wearable device, an HIPD 1000, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement units (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramhy (ECG or EKG) sensors configured to measure electrical activity of the heart to diagnose heart problems; (iii) electromyography (EMG) sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 7A and 7B illustrate example AR systems, in accordance with some embodiments. FIG. 7A shows a first AR system 700a and first example user interactions using a wrist-wearable device 800, a head-wearable device (e.g., AR device 900), and/or a handheld intermediary processing device (HIPD) 1000 and FIG. 7B shows a second AR system 700b and second example user interactions using a wrist-wearable device 800, AR device 900, and/or an HIPD 1000. As the skilled artisan will appreciate upon reading the descriptions provided herein, the above-example AR systems (described in detail below) can perform various functions and/or operations described above with reference to FIGS. 1A-6.

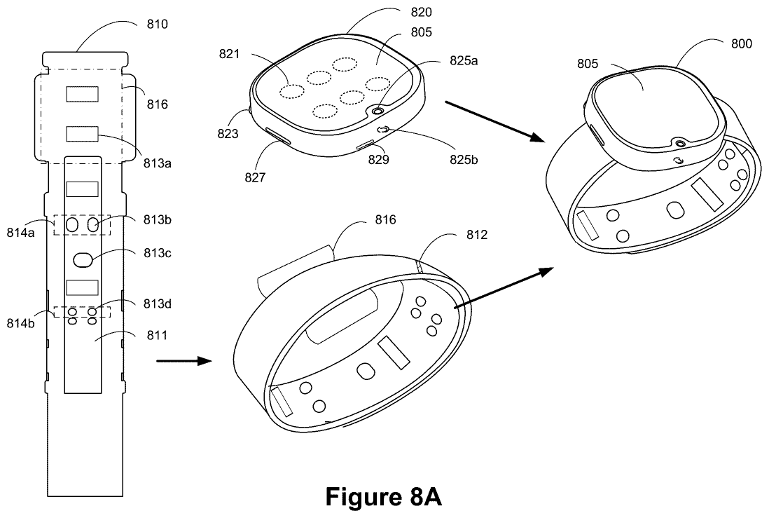

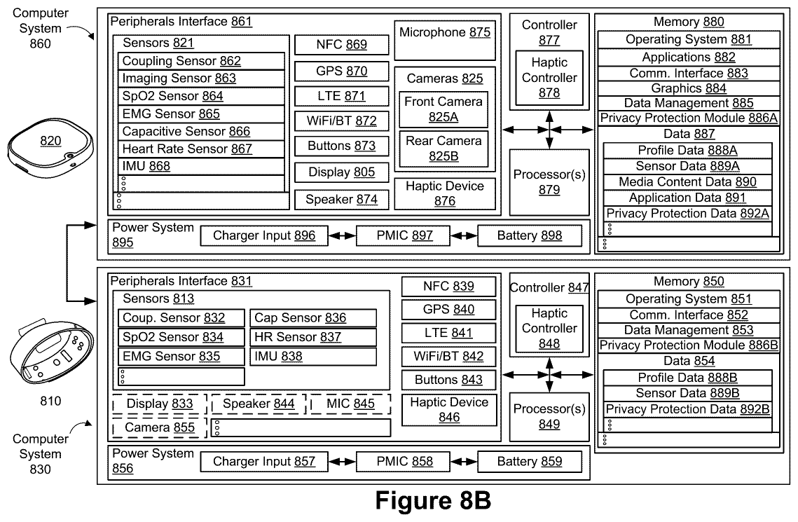

The wrist-wearable device 800 and its constituent components are described below in reference to FIGS. 8A-8B, the head-wearable devices and their constituent components are described below in reference to FIGS. 9A-9D, and the HIPD 1000 and its constituent components are described below in reference to FIGS. 10A-10B. The wrist-wearable device 800, the head-wearable devices, and/or the HIPD 1000 can communicatively couple via a network 725 (e.g., cellular, near-field, Wi-Fi, personal area network, or wireless LAN). Additionally, the wrist-wearable device 800, the head-wearable devices, and/or the HIPD 1000 can also communicatively couple with one or more servers 730, computers 740 (e.g., laptops or computers), mobile devices 750 (e.g., smartphones or tablets), and/or other electronic devices via the network 725 (e.g., cellular, near-field, Wi-Fi, personal area network, or wireless LAN).

Turning to FIG. 7A, a user 702 is shown wearing the wrist-wearable device 800 and the AR device 900 and having the HIPD 1000 on their desk. The wrist-wearable device 800, the AR device 900, and the HIPD 1000 facilitate user interaction with an AR environment. In particular, as shown by the first AR system 700a, the wrist-wearable device 800, the AR device 900, and/or the HIPD 1000 cause presentation of one or more avatars 704, digital representations of contacts 706, and virtual objects 708. As discussed below, the user 702 can interact with the one or more avatars 704, digital representations of the contacts 706, and virtual objects 708 via the wrist-wearable device 800, the AR device 900, and/or the HIPD 1000.

The user 702 can use any of the wrist-wearable device 800, the AR device 900, and/or the HIPD 1000 to provide user inputs. For example, the user 702 can perform one or more hand gestures that are detected by the wrist-wearable device 800 (e.g., using one or more EMG sensors and/or IMUs, described below in reference to FIGS. 8A-8B) and/or AR device 900 (e.g., using one or more image sensors or cameras, described below in reference to FIGS. 9A-9B) to provide a user input. Alternatively, or additionally, the user 702 can provide a user input via one or more touch surfaces of the wrist-wearable device 800, the AR device 900, and/or the HIPD 1000, and/or voice commands captured by a microphone of the wrist-wearable device 800, the AR device 900, and/or the HIPD 1000. In some embodiments, the wrist-wearable device 800, the AR device 900, and/or the HIPD 1000 include a digital assistant to help the user in providing a user input (e.g., completing a sequence of operations, suggesting different operations or commands, providing reminders, or confirming a command). In some embodiments, the user 702 can provide a user input via one or more facial gestures and/or facial expressions. For example, cameras of the wrist-wearable device 800, the AR device 900, and/or the HIPD 1000 can track the user 702's eyes for navigating a user interface.

The wrist-wearable device 800, the AR device 900, and/or the HIPD 1000 can operate alone or in conjunction to allow the user 702 to interact with the AR environment. In some embodiments, the HIPD 1000 is configured to operate as a central hub or control center for the wrist-wearable device 800, the AR device 900, and/or another communicatively coupled device. For example, the user 702 can provide an input to interact with the AR environment at any of the wrist-wearable device 800, the AR device 900, and/or the HIPD 1000, and the HIPD 1000 can identify one or more back-end and front-end tasks to cause the performance of the requested interaction and distribute instructions to cause the performance of the one or more back-end and front-end tasks at the wrist-wearable device 800, the AR device 900, and/or the HIPD 1000. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 10A-10B, the HIPD 1000 can perform the back-end tasks and provide the wrist-wearable device 800 and/or the AR device 900 operational data corresponding to the performed back-end tasks such that the wrist-wearable device 800 and/or the AR device 900 can perform the front-end tasks. In this way, the HIPD 1000, which has more computational resources and greater thermal headroom than the wrist-wearable device 800 and/or the AR device 900, performs computationally intensive tasks and reduces the computer resource utilization and/or power usage of the wrist-wearable device 800 and/or the AR device 900.

In the example shown by the first AR system 700a, the HIPD 1000 identifies one or more back-end tasks and front-end tasks associated with a user's request to initiate an AR video call with one or more other users (represented by the avatar 704 and the digital representation of the contact 706) and distributes instructions to cause the performance of the one or more back-end tasks and front-end tasks. In particular, the HIPD 1000 performs back-end tasks for processing and/or rendering image data (and other data) associated with the AR video call and provides operational data associated with the performed back-end tasks to the AR device 900 such that the AR device 900 performs front-end tasks for presenting the AR video call (e.g., presenting the avatar 704 and the digital representation of the contact 706).

In some embodiments, the HIPD 1000 can operate as a focal or anchor point for causing the presentation of information. This allows the user 702 to be generally aware of where information is presented. For example, as shown in the first AR system 700a, the avatar 704 and the digital representation of the contact 706 are presented above the HIPD 1000. In particular, the HIPD 1000 and the AR device 900 operate in conjunction to determine a location for presenting the avatar 704 and the digital representation of the contact 706. In some embodiments, information can be presented within a predetermined distance from the HIPD 1000 (e.g., within five meters). For example, as shown in the first AR system 700a, virtual object 708 is presented on the desk some distance from the HIPD 1000. Similar to the above example, the HIPD 1000 and the AR device 900 can operate in conjunction to determine a location for presenting the virtual object 708. Alternatively, in some embodiments, presentation of information is not bound by the HIPD 1000. More specifically, the avatar 704, the digital representation of the contact 706, and the virtual object 708 do not have to be presented within a predetermined distance of the HIPD 1000.

User inputs provided at the wrist-wearable device 800, the AR device 900, and/or the HIPD 1000 are coordinated such that the user can use any device to initiate, continue, and/or complete an operation. For example, the user 702 can provide a user input to the AR device 900 to cause the AR device 900 to present the virtual object 708 and, while the virtual object 708 is presented by the AR device 900, the user 702 can provide one or more hand gestures via the wrist-wearable device 800 to interact and/or manipulate the virtual object 708.

FIG. 7B shows the user 702 wearing the wrist-wearable device 800 and the AR device 900 and holding the HIPD 1000. In the second AR system 700b, the wrist-wearable device 800, the AR device 900, and/or the HIPD 1000 are used to receive and/or provide one or more messages to a contact of the user 702. In particular, the wrist-wearable device 800, the AR device 900, and/or the HIPD 1000 detect and coordinate one or more user inputs to initiate a messaging application and prepare a response to a received message via the messaging application.

In some embodiments, the user 702 initiates, via a user input, an application on the wrist-wearable device 800, the AR device 900, and/or the HIPD 1000 that causes the application to initiate on at least one device. For example, in the second AR system 700b, the user 702 performs a hand gesture associated with a command for initiating a messaging application (represented by messaging user interface 712), the wrist-wearable device 800 detects the hand gesture, and, based on a determination that the user 702 is wearing AR device 900, causes the AR device 900 to present a messaging user interface 712 of the messaging application. The AR device 900 can present the messaging user interface 712 to the user 702 via its display (e.g., as shown by user 702's field of view 710). In some embodiments, the application is initiated and can be run on the device (e.g., the wrist-wearable device 800, the AR device 900, and/or the HIPD 1000) that detects the user input to initiate the application, and the device provides another device operational data to cause the presentation of the messaging application. For example, the wrist-wearable device 800 can detect the user input to initiate a messaging application, initiate and run the messaging application, and provide operational data to the AR device 900 and/or the HIPD 1000 to cause presentation of the messaging application. Alternatively, the application can be initiated and run at a device other than the device that detected the user input. For example, the wrist-wearable device 800 can detect the hand gesture associated with initiating the messaging application and cause the HIPD 1000 to run the messaging application and coordinate the presentation of the messaging application.

Further, the user 702 can provide a user input provided at the wrist-wearable device 800, the AR device 900, and/or the HIPD 1000 to continue and/or complete an operation initiated at another device. For example, after initiating the messaging application via the wrist-wearable device 800 and while the AR device 900 presents the messaging user interface 712, the user 702 can provide an input at the HIPD 1000 to prepare a response (e.g., shown by the swipe gesture performed on the HIPD 1000). The user 702's gestures performed on the HIPD 1000 can be provided and/or displayed on another device. For example, the user 702's swipe gestures performed on the HIPD 1000 are displayed on a virtual keyboard of the messaging user interface 712 displayed by the AR device 900.

In some embodiments, the wrist-wearable device 800, the AR device 900, the HIPD 1000, and/or other communicatively coupled devices can present one or more notifications to the user 702. The notification can be an indication of a new message, an incoming call, an application update, a status update, etc. The user 702 can select the notification via the wrist-wearable device 800, the AR device 900, or the HIPD 1000 and cause presentation of an application or operation associated with the notification on at least one device. For example, the user 702 can receive a notification that a message was received at the wrist-wearable device 800, the AR device 900, the HIPD 1000, and/or other communicatively coupled device and provide a user input at the wrist-wearable device 800, the AR device 900, and/or the HIPD 1000 to review the notification, and the device detecting the user input can cause an application associated with the notification to be initiated and/or presented at the wrist-wearable device 800, the AR device 900, and/or the HIPD 1000.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 900 can present to the user 702 game application data and the HIPD 1000 can use a controller to provide inputs to the game. Similarly, the user 702 can use the wrist-wearable device 800 to initiate a camera of the AR device 900, and the user can use the wrist-wearable device 800, the AR device 900, and/or the HIPD 1000 to manipulate the image capture (e.g., zoom in or out or apply filters) and capture image data.

Having discussed example AR systems, devices for interacting with such AR systems, and other computing systems more generally, devices and components will now be discussed in greater detail below. Some definitions of devices and components that can be included in some or all of the example devices discussed below are defined here for case of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 8A and 8B illustrate an example wrist-wearable device 800, in accordance with some embodiments. The wrist-wearable device 800 is an instance of the wrist-wearable device 110 described in reference to FIGS. 1A-6 herein, such that the wrist-wearable device 110 should be understood to have the features of the wrist-wearable device 800 and vice versa. FIG. 8A illustrates components of the wrist-wearable device 800, which can be used individually or in combination, including combinations that include other electronic devices and/or electronic components.

FIG. 8A shows a wearable band 810 and a watch body 820 (or capsule) being coupled, as discussed below, to form the wrist-wearable device 800. The wrist-wearable device 800 can perform various functions and/or operations associated with navigating through user interfaces and selectively opening applications, as well as the functions and/or operations described above with reference to FIGS. 1A-1N and 4A-6.

As will be described in more detail below, operations executed by the wrist-wearable device 800 can include (i) presenting content to a user (e.g., displaying visual content via a display 805); (ii) detecting (e.g., sensing) user input (e.g., sensing a touch on peripheral button 823 and/or at a touch screen of the display 805, a hand gesture detected by sensors (e.g., biopotential sensors)); (iii) sensing biometric data via one or more sensors 813 (e.g., neuromuscular signals, heart rate, temperature, or sleep); messaging (e.g., text, speech, or video); image capture via one or more imaging devices or cameras 825; wireless communications (e.g., cellular, near-field, Wi-Fi, or personal area network); location determination; financial transactions; providing haptic feedback; alarms; notifications; biometric authentication; health monitoring; and/or sleep monitoring.

The above-example functions can be executed independently in the watch body 820, independently in the wearable band 810, and/or via an electronic communication between the watch body 820 and the wearable band 810. In some embodiments, functions can be executed on the wrist-wearable device 800 while an AR environment is being presented (e.g., via one of the AR systems 700a and 700b). As the skilled artisan will appreciate upon reading the descriptions provided herein, the novel wearable devices described herein can be used with other types of AR environments.

The wearable band 810 can be configured to be worn by a user such that an inner (or inside) surface of the wearable structure 811 of the wearable band 810 is in contact with the user's skin. When worn by a user, sensors 813 contact the user's skin. The sensors 813 can sense biometric data such as a user's heart rate, saturated oxygen level, temperature, sweat level, neuromuscular-signal sensors, or a combination thereof. The sensors 813 can also sense data about a user's environment, including a user's motion, altitude, location, orientation, gait, acceleration, position, or a combination thereof. In some embodiments, the sensors 813 are configured to track a position and/or motion of the wearable band 810. The one or more sensors 813 can include any of the sensors defined above and/or discussed below with respect to FIG. 8B.

The one or more sensors 813 can be distributed on an inside and/or an outside surface of the wearable band 810. In some embodiments, the one or more sensors 813 are uniformly spaced along the wearable band 810. Alternatively, in some embodiments, the one or more sensors 813 are positioned at distinct points along the wearable band 810. As shown in FIG. 8A, the one or more sensors 813 can be the same or distinct. For example, in some embodiments, the one or more sensors 813 can be shaped as a pill (e.g., sensor 813a), an oval, a circle, a square, an oblong (e.g., sensor 813c), and/or any other shape that maintains contact with the user's skin (e.g., such that neuromuscular signal and/or other biometric data can be accurately measured at the user's skin). In some embodiments, the one or more sensors 813 are aligned to form pairs of sensors (e.g., for sensing neuromuscular signals based on differential sensing within each respective sensor). For example, sensor 813b is aligned with an adjacent sensor to form sensor pair 814a, and sensor 813d is aligned with an adjacent sensor to form sensor pair 814b. In some embodiments, the wearable band 810 does not have a sensor pair. Alternatively, in some embodiments, the wearable band 810 has a predetermined number of sensor pairs (one pair of sensors, three pairs of sensors, four pairs of sensors, six pairs of sensors, or sixteen pairs of sensors).

The wearable band 810 can include any suitable number of sensors 813. In some embodiments, the amount and arrangements of sensors 813 depend on the particular application for which the wearable band 810 is used. For instance, a wearable band 810 configured as an armband, wristband, or chest-band may include a plurality of sensors 813 with a different number of sensors 813 and different arrangement for each use case, such as medical use cases, compared to gaming or general day-to-day use cases.

In accordance with some embodiments, the wearable band 810 further includes an electrical ground electrode and a shielding electrode. The electrical ground and shielding electrodes, like the sensors 813, can be distributed on the inside surface of the wearable band 810 such that they contact a portion of the user's skin. For example, the electrical ground and shielding electrodes can be at an inside surface of coupling mechanism 816 or an inside surface of a wearable structure 811. The electrical ground and shielding electrodes can be formed and/or use the same components as the sensors 813. In some embodiments, the wearable band 810 includes more than one electrical ground electrode and more than one shielding electrode.

The sensors 813 can be formed as part of the wearable structure 811 of the wearable band 810. In some embodiments, the sensors 813 are flush or substantially flush with the wearable structure 811 such that they do not extend beyond the surface of the wearable structure 811. While flush with the wearable structure 811, the sensors 813 are still configured to contact the user's skin (e.g., via a skin-contacting surface). Alternatively, in some embodiments, the sensors 813 extend beyond the wearable structure 811 a predetermined distance (e.g., 0.1 mm to 2 mm) to make contact and depress into the user's skin. In some embodiments, the sensors 813 are coupled to an actuator (not shown) configured to adjust an extension height (e.g., a distance from the surface of the wearable structure 811) of the sensors 813 such that the sensors 813 make contact and depress into the user's skin. In some embodiments, the actuators adjust the extension height between 0.01 mm to 1.2 mm. This allows the user to customize the positioning of the sensors 813 to improve the overall comfort of the wearable band 810 when worn while still allowing the sensors 813 to contact the user's skin. In some embodiments, the sensors 813 are indistinguishable from the wearable structure 811 when worn by the user.

The wearable structure 811 can be formed of an elastic material, elastomers, etc., configured to be stretched and fitted to be worn by the user. In some embodiments, the wearable structure 811 is a textile or woven fabric. As described above, the sensors 813 can be formed as part of a wearable structure 811. For example, the sensors 813 can be molded into the wearable structure 811 or be integrated into a woven fabric (e.g., the sensors 813 can be sewn into the fabric and mimic the pliability of fabric (e.g., the sensors 813 can be constructed from a series of woven strands of fabric)).

The wearable structure 811 can include flexible electronic connectors that interconnect the sensors 813, the electronic circuitry, and/or other electronic components (described below in reference to FIG. 8B) that are enclosed in the wearable band 810. In some embodiments, the flexible electronic connectors are configured to interconnect the sensors 813, the electronic circuitry, and/or other electronic components of the wearable band 810 with respective sensors and/or other electronic components of another electronic device (e.g., watch body 820). The flexible electronic connectors are configured to move with the wearable structure 811 such that the user adjustment to the wearable structure 811 (e.g., resizing, pulling, or folding) does not stress or strain the electrical coupling of components of the wearable band 810.

As described above, the wearable band 810 is configured to be worn by a user. In particular, the wearable band 810 can be shaped or otherwise manipulated to be worn by a user. For example, the wearable band 810 can be shaped to have a substantially circular shape such that it can be configured to be worn on the user's lower arm or wrist. Alternatively, the wearable band 810 can be shaped to be worn on another body part of the user, such as the user's upper arm (e.g., around a bicep), forearm, chest, legs, etc. The wearable band 810 can include a retaining mechanism 812 (e.g., a buckle or a hook and loop fastener) for securing the wearable band 810 to the user's wrist or other body part. While the wearable band 810 is worn by the user, the sensors 813 sense data (referred to as sensor data) from the user's skin. In particular, the sensors 813 of the wearable band 810 obtain (e.g., sense and record) neuromuscular signals.

The sensed data (e.g., sensed neuromuscular signals) can be used to detect and/or determine the user's intention to perform certain motor actions. In particular, the sensors 813 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 805 of the wrist-wearable device 800 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 813 can be used to provide a user with an enhanced interaction with a physical object (e.g., devices communicatively coupled with the wearable band 810) and/or a virtual object in an AR application generated by an AR system (e.g., user interface objects presented on the display 805 or another computing device (e.g., a smartphone)).

In some embodiments, the wearable band 810 includes one or more haptic devices 846 (FIG. 8B; e.g., a vibratory haptic actuator) that are configured to provide haptic feedback (e.g., a cutaneous and/or kinesthetic sensation) to the user's skin. The sensors 813 and/or the haptic devices 846 can be configured to operate in conjunction with multiple applications including, without limitation, health monitoring, social media, games, and AR (e.g., the applications associated with AR).

The wearable band 810 can also include a coupling mechanism 816 (e.g., a cradle or a shape of the coupling mechanism can correspond to the shape of the watch body 820 of the wrist-wearable device 800) for detachably coupling a capsule (e.g., a computing unit) or watch body 820 (via a coupling surface of the watch body 820) to the wearable band 810. In particular, the coupling mechanism 816 can be configured to receive a coupling surface proximate to the bottom side of the watch body 820 (e.g., a side opposite to a front side of the watch body 820 where the display 805 is located), such that a user can push the watch body 820 downward into the coupling mechanism 816 to attach the watch body 820 to the coupling mechanism 816. In some embodiments, the coupling mechanism 816 can be configured to receive a top side of the watch body 820 (e.g., a side proximate to the front side of the watch body 820 where the display 805 is located) that is pushed upward into the cradle, as opposed to being pushed downward into the coupling mechanism 816. In some embodiments, the coupling mechanism 816 is an integrated component of the wearable band 810 such that the wearable band 810 and the coupling mechanism 816 are a single unitary structure. In some embodiments, the coupling mechanism 816 is a type of frame or shell that allows the watch body 820 coupling surface to be retained within or on the wearable band 810 coupling mechanism 816 (e.g., a cradle, a tracker band, a support base, or a clasp).

The coupling mechanism 816 can allow for the watch body 820 to be detachably coupled to the wearable band 810 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 820 to the wearable band 810 and to decouple the watch body 820 from the wearable band 810. For example, a user can twist, slide, turn, push, pull, or rotate the watch body 820 relative to the wearable band 810, or a combination thereof, to attach the watch body 820 to the wearable band 810 and to detach the watch body 820 from the wearable band 810. Alternatively, as discussed below, in some embodiments, the watch body 820 can be decoupled from the wearable band 810 by actuation of the release mechanism 829.

The wearable band 810 can be coupled with a watch body 820 to increase the functionality of the wearable band 810 (e.g., converting the wearable band 810 into a wrist-wearable device 800, adding an additional computing unit and/or battery to increase computational resources and/or a battery life of the wearable band 810, or adding additional sensors to improve sensed data). As described above, the wearable band 810 (and the coupling mechanism 816) is configured to operate independently (e.g., execute functions independently) from watch body 820. For example, the coupling mechanism 816 can include one or more sensors 813 that contact a user's skin when the wearable band 810 is worn by the user and provide sensor data for determining control commands.

A user can detach the watch body 820 (or capsule) from the wearable band 810 in order to reduce the encumbrance of the wrist-wearable device 800 to the user. For embodiments in which the watch body 820 is removable, the watch body 820 can be referred to as a removable structure, such that in these embodiments the wrist-wearable device 800 includes a wearable portion (e.g., the wearable band 810) and a removable structure (the watch body 820).

Turning to the watch body 820, the watch body 820 can have a substantially rectangular or circular shape. The watch body 820 is configured to be worn by the user on their wrist or on another body part. More specifically, the watch body 820 is sized to be easily carried by the user, attached on a portion of the user's clothing, and/or coupled to the wearable band 810 (forming the wrist-wearable device 800). As described above, the watch body 820 can have a shape corresponding to the coupling mechanism 816 of the wearable band 810. In some embodiments, the watch body 820 includes a single release mechanism 829 or multiple release mechanisms (e.g., two release mechanisms 829 positioned on opposing sides of the watch body 820, such as spring-loaded buttons) for decoupling the watch body 820 and the wearable band 810. The release mechanism 829 can include, without limitation, a button, a knob, a plunger, a handle, a lever, a fastener, a clasp, a dial, a latch, or a combination thereof.

A user can actuate the release mechanism 829 by pushing, turning, lifting, depressing, shifting, or performing other actions on the release mechanism 829. Actuation of the release mechanism 829 can release (e.g., decouple) the watch body 820 from the coupling mechanism 816 of the wearable band 810, allowing the user to use the watch body 820 independently from wearable band 810 and vice versa. For example, decoupling the watch body 820 from the wearable band 810 can allow the user to capture images using the rear-facing camera 825b. Although the coupling mechanism 816 is shown positioned at a corner of the watch body 820, the release mechanism 829 can be positioned anywhere on the watch body 820 that is convenient for the user to actuate. In addition, in some embodiments, the wearable band 810 can also include a respective release mechanism for decoupling the watch body 820 from the coupling mechanism 816. In some embodiments, the release mechanism 829 is optional and the watch body 820 can be decoupled from the coupling mechanism 816, as described above (e.g., via twisting or rotating).

The watch body 820 can include one or more peripheral buttons 823 and 827 for performing various operations at the watch body 820. For example, the peripheral buttons 823 and 827 can be used to turn on or wake (e.g., transition from a sleep state to an active state) the display 805, unlock the watch body 820, increase or decrease volume, increase or decrease brightness, interact with one or more applications, interact with one or more user interfaces. Additionally, or alternatively, in some embodiments, the display 805 operates as a touch screen and allows the user to provide one or more inputs for interacting with the watch body 820.

In some embodiments, the watch body 820 includes one or more sensors 821. The sensors 821 of the watch body 820 can be the same or distinct from the sensors 813 of the wearable band 810. The sensors 821 of the watch body 820 can be distributed on an inside and/or an outside surface of the watch body 820. In some embodiments, the sensors 821 are configured to contact a user's skin when the watch body 820 is worn by the user. For example, the sensors 821 can be placed on the bottom side of the watch body 820 and the coupling mechanism 816 can be a cradle with an opening that allows the bottom side of the watch body 820 to directly contact the user's skin. Alternatively, in some embodiments, the watch body 820 does not include sensors that are configured to contact the user's skin (e.g., including sensors internal and/or external to the watch body 820 that are configured to sense data of the watch body 820 and the watch body 820's surrounding environment). In some embodiments, the sensors 813 are configured to track a position and/or motion of the watch body 820.

The watch body 820 and the wearable band 810 can share data using a wired communication method (e.g., a Universal Asynchronous Receiver/Transmitter (UART) or a USB transceiver) and/or a wireless communication method (e.g., near-field communication or Bluetooth). For example, the watch body 820 and the wearable band 810 can share data sensed by the sensors 813 and 821, as well as application- and device-specific information (e.g., active and/or available applications), output devices (e.g., display or speakers), and/or input devices (e.g., touch screens, microphones, or imaging sensors).

In some embodiments, the watch body 820 can include, without limitation, a front-facing camera 825a and/or a rear-facing camera 825b, sensors 821 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 8B; imaging sensor 863), a touch sensor, a sweat sensor). In some embodiments, the watch body 820 can include one or more haptic devices 876 (FIG. 8B; a vibratory haptic actuator) that is configured to provide haptic feedback (e.g., a cutaneous and/or kinesthetic sensation) to the user. The sensors 821 and/or the haptic device 876 can also be configured to operate in conjunction with multiple applications, including, without limitation, health-monitoring applications, social media applications, game applications, and AR applications (e.g., the applications associated with AR).

As described above, the watch body 820 and the wearable band 810, when coupled, can form the wrist-wearable device 800. When coupled, the watch body 820 and wearable band 810 operate as a single device to execute functions (e.g., operations, detections, or communications) described herein. In some embodiments, each device is provided with particular instructions for performing the one or more operations of the wrist-wearable device 800. For example, in accordance with a determination that the watch body 820 does not include neuromuscular-signal sensors, the wearable band 810 can include alternative instructions for performing associated instructions (e.g., providing sensed neuromuscular-signal data to the watch body 820 via a different electronic device). Operations of the wrist-wearable device 800 can be performed by the watch body 820 alone or in conjunction with the wearable band 810 (e.g., via respective processors and/or hardware components) and vice versa. In some embodiments, operations of the wrist-wearable device 800, the watch body 820, and/or the wearable band 810 can be performed in conjunction with one or more processors and/or hardware components of another communicatively coupled device (e.g., FIGS. 10A-10B; the HIPD 1000).

As described below with reference to the block diagram of FIG. 8B, the wearable band 810 and/or the watch body 820 can each include independent resources required to independently execute functions. For example, the wearable band 810 and/or the watch body 820 can each include a power source (e.g., a battery), a memory, data storage, a processor (e.g., a CPU), communications, a light source, and/or input/output devices.

FIG. 8B shows block diagrams of a computing system 830 corresponding to the wearable band 810 and a computing system 860 corresponding to the watch body 820, according to some embodiments. A computing system of the wrist-wearable device 800 includes a combination of components of the wearable band computing system 830 and the watch body computing system 860, in accordance with some embodiments.

The watch body 820 and/or the wearable band 810 can include one or more components shown in watch body computing system 860. In some embodiments, a single integrated circuit includes all or a substantial portion of the components of the watch body computing system 860 that are included in a single integrated circuit. Alternatively, in some embodiments, components of the watch body computing system 860 are included in a plurality of integrated circuits that are communicatively coupled. In some embodiments, the watch body computing system 860 is configured to couple (e.g., via a wired or wireless connection) with the wearable band computing system 830, which allows the computing systems to share components, distribute tasks, and/or perform other operations described herein (individually or as a single device).

The watch body computing system 860 can include one or more processors 879, a controller 877, a peripherals interface 861, a power system 895, and memory (e.g., a memory 880), each of which are defined above and described in more detail below.

The power system 895 can include a charger input 896, a power-management integrated circuit (PMIC) 897, and a battery 898, each of which are defined above. In some embodiments, a watch body 820 and a wearable band 810 can have respective charger inputs (e.g., charger inputs 896 and 857), respective batteries (e.g., batteries 898 and 859), and can share power with each other (e.g., the watch body 820 can power and/or charge the wearable band 810 and vice versa). Although watch body 820 and/or the wearable band 810 can include respective charger inputs, a single charger input can charge both devices when coupled. The watch body 820 and the wearable band 810 can receive a charge using a variety of techniques. In some embodiments, the watch body 820 and the wearable band 810 can use a wired charging assembly (e.g., power cords) to receive the charge. Alternatively, or in addition, the watch body 820 and/or the wearable band 810 can be configured for wireless charging. For example, a portable charging device can be designed to mate with a portion of the watch body 820 and/or wearable band 810 and wirelessly deliver usable power to a battery of the watch body 820 and/or the wearable band 810. The watch body 820 and the wearable band 810 can have independent power systems (e.g., power system 895 and 856) to enable each to operate independently. The watch body 820 and the wearable band 810 can also share power (e.g., one can charge the other) via respective PMICs (e.g., PMICs 897 and 858) that can share power over power and ground conductors and/or over wireless charging antennas.

In some embodiments, the peripherals interface 861 can include one or more sensors 821, many of which listed below are defined above. The sensors 821 can include one or more coupling sensors 862 for detecting when the watch body 820 is coupled with another electronic device (e.g., a wearable band 810). The sensors 821 can include imaging sensors 863 (one or more of the cameras 825 and/or separate imaging sensors 863 (e.g., thermal-imaging sensors)). In some embodiments, the sensors 821 include one or more SpO2 sensors 864. In some embodiments, the sensors 821 include one or more biopotential-signal sensors (e.g., EMG sensors 865, which may be disposed on a user-facing portion of the watch body 820 and/or the wearable band 810). In some embodiments, the sensors 821 include one or more capacitive sensors 866. In some embodiments, the sensors 821 include one or more heart rate sensors 867. In some embodiments, the sensors 821 include one or more IMUs 868. In some embodiments, one or more IMUs 868 can be configured to detect movement of a user's hand or other location where the watch body 820 is placed or held.

In some embodiments, the peripherals interface 861 includes an NFC component 869, a GPS component 870, a long-term evolution (LTE) component 871, and/or a Wi-Fi and/or Bluetooth communication component 872. In some embodiments, the peripherals interface 861 includes one or more buttons 873 (e.g., the peripheral buttons 823 and 827 in FIG. 8A), which, when selected by a user, cause operations to be performed at the watch body 820. In some embodiments, the peripherals interface 861 includes one or more indicators, such as a light-emitting diode (LED), to provide a user with visual indicators (e.g., message received, low battery, an active microphone, and/or a camera).

The watch body 820 can include at least one display 805 for displaying visual representations of information or data to the user, including user-interface elements and/or three-dimensional (3D) virtual objects. The display can also include a touch screen for inputting user inputs, such as touch gestures, swipe gestures, and the like. The watch body 820 can include at least one speaker 874 and at least one microphone 875 for providing audio signals to the user and receiving audio input from the user. The user can provide user inputs through the microphone 875 and can also receive audio output from the speaker 874 as part of a haptic event provided by the haptic controller 878. The watch body 820 can include at least one camera 825, including a front-facing camera 825a and a rear-facing camera 825b. The cameras 825 can include ultra-wide-angle cameras, wide-angle cameras, fish-eye cameras, spherical cameras, telephoto cameras, depth-sensing cameras, or other types of cameras.

The watch body computing system 860 can include one or more haptic controllers 878 and associated componentry (e.g., haptic devices 876) for providing haptic events at the watch body 820 (e.g., a vibrating sensation or audio output in response to an event at the watch body 820). The haptic controllers 878 can communicate with one or more haptic devices 876, such as electroacoustic devices, including a speaker of the one or more speakers 874 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 878 can provide haptic events to respective haptic actuators that are capable of being sensed by a user of the watch body 820. In some embodiments, the one or more haptic controllers 878 can receive input signals from an application of the applications 882.

In some embodiments, the computer system 830 and/or the computer system 860 can include memory 880, which can be controlled by a memory controller of the one or more controllers 877 and/or one or more processors 879. In some embodiments, software components stored in the memory 880 include one or more applications 882 configured to perform operations at the watch body 820. In some embodiments, the one or more applications 882 include games, word processors, messaging applications, calling applications, web browsers, social media applications, media-streaming applications, financial applications, calendars, clocks, etc. In some embodiments, software components stored in the memory 880 include one or more communication interface modules 883 as defined above. In some embodiments, software components stored in the memory 880 include one or more graphics modules 884 for rendering, encoding, and/or decoding audio and/or visual data; and one or more data management modules 885 for collecting, organizing, and/or providing access to the data 887 stored in memory 880. In some embodiments, software components stored in the memory 880 include a privacy protection module 886A, which is configured to perform the features described above in reference to FIGS. 1A-6. In particular, the privacy protection module 886A is configured to detect privacy indicator 220 tampering, concealment, and/or obstruction and restricting use of an imaging device when privacy indicator 220 tampering is detected. In some embodiments, one or more of applications 882 and/or one or more modules can work in conjunction with one another to perform various tasks at the watch body 820.

In some embodiments, software components stored in the memory 880 can include one or more operating systems 881 (e.g., a Linux-based operating system, an Android operating system). The memory 880 can also include data 887. The data 887 can include profile data 888A, sensor data 889A, media content data 890, application data 891, and privacy protection data 892A, which stores data related to the performance of the features described above in reference to FIGS. 1A-6. Specifically, the privacy protection data 892A stores one or more tampering threshold parameters, one or more absolute thresholds, and/or one or more models for detecting privacy-indicator tampering.

It should be appreciated that the watch body computing system 860 is an example of a computing system within the watch body 820, and that the watch body 820 can have more or fewer components than shown in the watch body computing system 860, combine two or more components, and/or have a different configuration and/or arrangement of the components. The various components shown in watch body computing system 860 are implemented in hardware, software, firmware, or a combination thereof, including one or more signal processing and/or application-specific integrated circuits.

Turning to the wearable band computing system 830, one or more components that can be included in the wearable band 810 are shown. The wearable band computing system 830 can include more or fewer components than shown in the watch body computing system 860, combine two or more components, and/or have a different configuration and/or arrangement of some or all of the components. In some embodiments, all, or a substantial portion of the components of the wearable band computing system 830 are included in a single integrated circuit. Alternatively, in some embodiments, components of the wearable band computing system 830 are included in a plurality of integrated circuits that are communicatively coupled. As described above, in some embodiments, the wearable band computing system 830 is configured to couple (e.g., via a wired or wireless connection) with the watch body computing system 860, which allows the computing systems to share components, distribute tasks, and/or perform other operations described herein (individually or as a single device).

The wearable band computing system 830, similar to the watch body computing system 860, can include one or more processors 849, one or more controllers 847 (including one or more haptics controller 848), a peripherals interface 831 that can include one or more sensors 813 and other peripheral devices, power source (e.g., a power system 856), and memory (e.g., a memory 850) that includes an operating system (e.g., an operating system 851), data (e.g., data 854 including profile data 888B, sensor data 889B, privacy protection data 892B), and one or more modules (e.g., a communications interface module 852, a data management module 853, a privacy protection module 886B).

The one or more sensors 813 can be analogous to sensors 821 of the computer system 860 in light of the definitions above. For example, sensors 813 can include one or more coupling sensors 832, one or more SpO2 sensors 834, one or more EMG sensors 835, one or more capacitive sensors 836, one or more heart rate sensors 837, and one or more IMU sensors 838.

The peripherals interface 831 can also include other components analogous to those included in the peripheral interface 861 of the computer system 860, including an NFC component 839, a GPS component 840, an LTE component 841, a Wi-Fi and/or Bluetooth communication component 842, and/or one or more haptic devices 876 as described above in reference to peripherals interface 861. In some embodiments, the peripherals interface 831 includes one or more buttons 843, a display 833, a speaker 844, a microphone 845, and a camera 855. In some embodiments, the peripherals interface 831 includes one or more indicators, such as an LED.

It should be appreciated that the wearable band computing system 830 is an example of a computing system within the wearable band 810, and that the wearable band 810 can have more or fewer components than shown in the wearable band computing system 830, combine two or more components, and/or have a different configuration and/or arrangement of the components. The various components shown in wearable band computing system 830 can be implemented in one or a combination of hardware, software, and firmware, including one or more signal processing and/or application-specific integrated circuits.

The wrist-wearable device 800 with respect to FIG. 8A is an example of the wearable band 810 and the watch body 820 coupled, so the wrist-wearable device 800 will be understood to include the components shown and described for the wearable band computing system 830 and the watch body computing system 860. In some embodiments, wrist-wearable device 800 has a split architecture (e.g., a split mechanical architecture or a split electrical architecture) between the watch body 820 and the wearable band 810. In other words, all of the components shown in the wearable band computing system 830 and the watch body computing system 860 can be housed or otherwise disposed in a combined watch device 800, or within individual components of the watch body 820, wearable band 810, and/or portions thereof (e.g., a coupling mechanism 816 of the wearable band 810).

The techniques described above can be used with any device for sensing neuromuscular signals, including the arm-wearable devices of FIGS. 8A-8B, but could also be used with other types of wearable devices for sensing neuromuscular signals (such as body-wearable or head-wearable devices that might have neuromuscular sensors closer to the brain or spinal column).

In some embodiments, a wrist-wearable device 800 can be used in conjunction with a head-wearable device described below (e.g., AR device 900 and VR device 910) and/or an HIPD 1000, and the wrist-wearable device 800 can also be configured to be used to allow a user to control aspects of the AR (e.g., by using EMG-based gestures to control user interface objects in the AR and/or by allowing a user to interact with the touchscreen on the wrist-wearable device to also control aspects of the artificial reality). Having thus described example wrist-wearable device, attention will now be turned to example head-wearable devices, such AR device 900 and VR device 910.

### Example Head-Wearable Devices

FIGS. 9A-9C show example head-wearable devices, in accordance with some embodiments. Head-wearable devices can include, but are not limited to, AR devices 900 (e.g., AR or smart eyewear devices, such as smart glasses, smart monocles, smart contacts, etc.), VR devices 910 (e.g., VR headsets or head-mounted displays (HMDs)), or other ocularly coupled devices. The AR devices 900 and the VR devices 910 are instances of the head-wearable devices 120, 205, 207, and 209 described in reference to FIGS. 1A-2D herein, such that the head-wearable devices 120, 205, 207, and 209 should be understood to have the features of the AR devices 900 and/or the VR devices 910 and vice versa. The AR devices 900 and the VR devices 910 can perform various functions and/or operations associated with navigating through user interfaces and selectively opening applications, as well as the functions and/or operations described above with reference to FIGS. 1A-6.

In some embodiments, an AR system (e.g., FIGS. 7A-7D-2; AR systems 700a and 700b) includes an AR device 900 (as shown in FIG. 9A) and/or VR device 910 (as shown in FIGS. 9B-1-B-2). In some embodiments, the AR device 900 and the VR device 910 can include one or more analogous components (e.g., components for presenting interactive AR environments, such as processors, memory, and/or presentation devices, including one or more displays and/or one or more waveguides), some of which are described in more detail with respect to FIG. 9C. The head-wearable devices can use display projectors (e.g., display projector assemblies 907A and 907B) and/or waveguides for projecting representations of data to a user. Some embodiments of head-wearable devices do not include displays.

FIG. 9A shows an example visual depiction of the AR device 900 (e.g., which may also be described herein as augmented-reality glasses and/or smart glasses). The AR device 900 can work in conjunction with additional electronic components that are not shown in FIGS. 9A, such as a wearable accessory device and/or an intermediary processing device, in electronic communication or otherwise configured to be used in conjunction with the AR device 900. In some embodiments, the wearable accessory device and/or the intermediary processing device may be configured to couple with the AR device 900 via a coupling mechanism in electronic communication with a coupling sensor 924, where the coupling sensor 924 can detect when an electronic device becomes physically or electronically coupled with the AR device 900. In some embodiments, the AR device 900 can be configured to couple to a housing (e.g., a portion of frame 904 or temple arms 905), which may include one or more additional coupling mechanisms configured to couple with additional accessory devices. The components shown in FIG. 9A can be implemented in hardware, software, firmware, or a combination thereof, including one or more signal-processing components and/or application-specific integrated circuits (ASICs).

The AR device 900 includes mechanical glasses components, including a frame 904 configured to hold one or more lenses (e.g., one or both lenses 906-1 and 906-2). One of ordinary skill in the art will appreciate that the AR device 900 can include additional mechanical components, such as hinges configured to allow portions of the frame 904 of the AR device 900 to be folded and unfolded, a bridge configured to span the gap between the lenses 906-1 and 906-2 and rest on the user's nose, nose pads configured to rest on the bridge of the nose and provide support for the AR device 900, earpieces configured to rest on the user's ears and provide additional support for the AR device 900, temple arms 905 configured to extend from the hinges to the earpieces of the AR device 900, and the like. One of ordinary skill in the art will further appreciate that some examples of the AR device 900 can include none of the mechanical components described herein. For example, smart contact lenses configured to present AR to users may not include any components of the AR device 900.

The lenses 906-1 and 906-2 can be individual displays or display devices (e.g., a waveguide for projected representations). The lenses 906-1 and 906-2 may act together or independently to present an image or series of images to a user. In some embodiments, the lenses 906-1 and 906-2 can operate in conjunction with one or more display projector assemblies 907A and 907B to present image data to a user. While the AR device 900 includes two displays, embodiments of this disclosure may be implemented in AR devices with a single near-eye display (NED) or more than two NEDS.

The AR device 900 includes electronic components, many of which will be described in more detail below with respect to FIG. 9C. Some example electronic components are illustrated in FIG. 9A, including sensors 923-1, 923-2, 923-3, 923-4, 923-5, and 923-6, which can be distributed along a substantial portion of the frame 904 of the AR device 900. The different types of sensors are described below in reference to FIG. 9C. The AR device 900 also includes a left camera 939A and a right camera 939B, which are located on different sides of the frame 904. And the eyewear device includes one or more processors 948A and 948B (e.g., an integral microprocessor, such as an ASIC) that is embedded into a portion of the frame 904.

FIGS. 9B-1 and 9B-2 show an example visual depiction of the VR device 910 (e.g., a head-mounted display (HMD) 912, also referred to herein as an AR headset, a head-wearable device, or a VR headset). The HMD 912 includes a front body 914 and a frame 916 (e.g., a strap or band) shaped to fit around a user's head. In some embodiments, the front body 914 and/or the frame 916 includes one or more electronic elements for facilitating presentation of and/or interactions with an AR and/or VR system (e.g., displays, processors (e.g., processor 948A-1), IMUs, tracking emitters or detectors, or sensors). In some embodiments, the HMD 912 includes output audio transducers (e.g., an audio transducer 918-1), as shown in FIG. 9B-2. In some embodiments, one or more components, such as the output audio transducer(s) 918 and the frame 916, can be configured to attach and detach (e.g., are detachably attachable) to the HMD 912 (e.g., a portion or all of the frame 916 and/or the output audio transducer 918), as shown in FIG. 9B-2. In some embodiments, coupling a detachable component to the HMD 912 causes the detachable component to come into electronic communication with the HMD 912. The VR device 910 includes electronic components, many of which will be described in more detail below with respect to FIG. 9C.

FIGS. 9B-1 and 9B-2 also show that the VR device 910 having one or more cameras, such as the left camera 939A and the right camera 939B, which can be analogous to the left and right cameras on the frame 904 of the AR device 900. In some embodiments, the VR device 910 includes one or more additional cameras (e.g., cameras 939C and 939D), which can be configured to augment image data obtained by the cameras 939A and 939B by providing more information. For example, the camera 939C can be used to supply color information that is not discerned by cameras 939A and 939B. In some embodiments, one or more of the cameras 939A to 939D can include an optional IR (infrared) cut filter configured to remove IR light from being received at the respective camera sensors.

The VR device 910 can include a housing 990 storing one or more components of the VR device 910 and/or additional components of the VR device 910. The housing 990 can be a modular electronic device configured to couple with the VR device 910 (or an AR device 900) and supplement and/or extend the capabilities of the VR device 910 (or an AR device 900). For example, the housing 990 can include additional sensors, cameras, power sources, and processors (e.g., processor 948A-2) to improve and/or increase the functionality of the VR device 910. Examples of the different components included in the housing 990 are described below in reference to FIG. 9C.

Alternatively, or in addition, in some embodiments, the head-wearable device, such as the VR device 910 and/or the AR device 900, includes, or is communicatively coupled to, another external device (e.g., a paired device), such as an HIPD 10 (discussed below in reference to FIGS. 10A-10B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 1000, an optional neckband, and/or a wearable accessory device) with the head-wearable devices (e.g., an AR device 900 and/or a VR device 910) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 1000) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 1000, can process information generated by one or more of its sensors and/or information provided by other communicatively coupled devices. For example, a head-wearable device can include an IMU, and the intermediary processing device (a neckband and/or an HIPD 1000) can compute all inertial and spatial calculations from the IMUs located on the head-wearable device. Additional examples of processing performed by a communicatively coupled device, such as the HIPD 1000, are provided below in reference to FIGS. 10A and 10B.

AR systems may include a variety of types of visual feedback mechanisms. For example, display devices in the AR devices 900 and/or the VR devices 910 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 900 and/or the VR device 910 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an AR with actual reality, substantially replace one or more of a user's sensory perceptions of the real world with a virtual experience.

While the example head-wearable devices are respectively described herein as the AR device 900 and the VR device 910, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 900 and/or the VR device 910 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 800, an HIPD 1000), and/or other devices described herein.

FIG. 9C illustrates a computing system 920 and an optional housing 990, each of which shows components that can be included in a head-wearable device (e.g., the AR device 900 and/or the VR device 910). In some embodiments, more or fewer components can be included in the optional housing 990 depending on practical restraints of the respective head-wearable device being described. Additionally or alternatively, the optional housing 990 can include additional components to expand and/or augment the functionality of a head-wearable device.

In some embodiments, the computing system 920 and/or the optional housing 990 can include one or more peripheral interfaces 922A and 922B, one or more power systems 942A and 942B (including charger input 943, PMIC 944, and battery 945), one or more controllers 946A and 946B (including one or more haptic controllers 947), one or more processors 948A and 948B (as defined above, including any of the examples provided), and memory 950A and 950B, which can all be in electronic communication with each other. For example, the one or more processors 948A and/or 948B can be configured to execute instructions stored in the memory 950A and/or 950B, which can cause a controller of the one or more controllers 946A and/or 946B to cause operations to be performed at one or more peripheral devices of the peripherals interfaces 922A and/or 922B. In some embodiments, each operation described can occur based on electrical power provided by the power system 942A and/or 942B.

In some embodiments, the peripherals interface 922A can include one or more devices configured to be part of the computing system 920, many of which have been defined above and/or described with respect to wrist-wearable devices shown in FIGS. 8A and 8B. For example, the peripherals interface can include one or more sensors 923A. Some example sensors include one or more coupling sensors 924, one or more acoustic sensors 925, one or more imaging sensors 926, one or more EMG sensors 927, one or more capacitive sensors 928, and/or one or more IMUs 929. In some embodiments, the sensors 923A further include depth sensors 967, light sensors 968, and/or any other types of sensors defined above or described with respect to any other embodiments discussed herein.

In some embodiments, the peripherals interface can include one or more additional peripheral devices, including one or more NFC devices 930, one or more GPS devices 931, one or more LTE devices 932, one or more Wi-Fi and/or Bluetooth devices 933, one or more buttons 934 (e.g., including buttons that are slidable or otherwise adjustable), one or more displays 935A, one or more speakers 936A, one or more microphones 937A, one or more cameras 938A (e.g., including the first camera 939-1 through nth camera 939-n, which are analogous to the left camera 939A and/or the right camera 939B), one or more haptic devices 940, and/or any other types of peripheral devices defined above or described with respect to any other embodiments discussed herein.

The head-wearable devices can include a variety of types of visual feedback mechanisms (e.g., presentation devices). For example, display devices in the AR device 900 and/or the VR device 910 can include one or more LCDs, LED displays, OLED displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 935A can be coupled to each of the lenses 906-1 and 906-2 of the AR device 900. The displays 935A coupled to each of the lenses 906-1 and 906-2 can act together or independently to present an image or series of images to a user. In some embodiments, the AR device 900 and/or the VR device 910 includes a single display 935A (e.g., a near-eye display) or more than two displays 935A.

In some embodiments, a first set of one or more displays 935A can be used to present an augmented-reality environment, and a second set of one or more display devices 935A can be used to present a VR environment. In some embodiments, one or more waveguides are used in conjunction with presenting AR content to the user of the AR device 900 and/or the VR device 910 (e.g., as a means of delivering light from a display projector assembly and/or one or more displays 935A to the user's eyes). In some embodiments, one or more waveguides are fully or partially integrated into the AR device 900 and/or the VR device 910. Additionally, or alternatively, to display screens, some AR systems include one or more projection systems. For example, display devices in the AR device 900 and/or the VR device 910 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 935A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15 percent-50 percent of the ambient light and/or the real-world live view) can be passed through the user interface element, such that the user can distinguish at least a portion of the physical environment over which the user interface element is being displayed.

The head-wearable devices can include one or more external displays 935A for presenting information to users. For example, an external display 935A can be used to show a current battery level, network activity (e.g., connected, disconnected), current activity (e.g., playing a game, in a call, in a meeting, or watching a movie), and/or other relevant information. In some embodiments, the external displays 935A can be used to communicate with others. For example, a user of the head-wearable device can cause the external displays 935A to present a “do not disturb” notification. The external displays 935A can also be used by the user to share any information captured by the one or more components of the peripherals interface 922A and/or generated by the head-wearable device (e.g., during operation and/or performance of one or more applications).

The memory 950A can include instructions and/or data executable by one or more processors 948A (and/or processors 948B of the housing 990) and/or a memory controller of the one or more controllers 946A (and/or controller 946B of the housing 990). The memory 950A can include one or more operating systems 951, one or more applications 952, one or more communication interface modules 953A, one or more graphics modules 954A, one or more AR processing modules 955A, privacy protection module 956A (e.g., analogous to privacy protection module 886; FIG. 8B) for performing the features described above in reference to FIGS. 1A-6, and/or any other types of modules or components defined above or described with respect to any other embodiments discussed herein.

The data 960 stored in memory 950A can be used in conjunction with one or more of the applications and/or programs discussed above. The data 960 can include profile data 961, sensor data 962, media content data 963, AR application data 964, privacy protection data 965 (e.g., analogous to privacy protection data 892; FIG. 8B) for storing data related to the performance of the features described above in reference to FIGS. 1A-6; and/or any other types of data defined above or described with respect to any other embodiments discussed herein.

In some embodiments, the controller 946A of the head-wearable devices processes information generated by the sensors 923A on the head-wearable devices and/or another component of the head-wearable devices and/or communicatively coupled with the head-wearable devices (e.g., components of the housing 990, such as components of peripherals interface 922B). For example, the controller 946A can process information from the acoustic sensors 925 and/or image sensors 926. For each detected sound, the controller 946A can perform a direction of arrival (DOA) estimation to estimate a direction from which the detected sound arrived at a head-wearable device. As one or more of the acoustic sensors 925 detect sounds, the controller 946A can populate an audio data set with the information (e.g., represented by sensor data 962).

In some embodiments, a physical electronic connector can convey information between the head-wearable devices and another electronic device, and/or between one or more processors 948A of the head-wearable devices and the controller 946A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1000) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 900 and/or the VR device 910 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 9B-1 and 9B-2 show the VR device 910 having cameras 939A-939D, which can be used to provide depth information for creating a voxel field and a 2D mesh to provide object information to the user to avoid collisions.

The optional housing 990 can include analogous components to those described above with respect to the computing system 920. For example, the optional housing 990 can include a respective peripherals interface 922B, including more or fewer components to those described above with respect to the peripherals interface 922A. As described above, the components of the optional housing 990 can be used to augment and/or expand on the functionality of the head-wearable devices. For example, the optional housing 990 can include respective sensors 923B, speakers 936B, displays 935B, microphones 937B, cameras 938B, and/or other components to capture and/or present data. Similarly, the optional housing 990 can include one or more processors 948B, controllers 946B, and/or memory 950B (including respective communication interface modules 953B, one or more graphics modules 954B, one or more AR processing modules 955B) that can be used individually and/or in conjunction with the components of the computing system 920.

The techniques described above in FIGS. 9A-9C can be used with different head-wearable devices. In some embodiments, the head-wearable devices (e.g., the AR device 900 and/or the VR device 910) can be used in conjunction with one or more wearable devices such as a wrist-wearable device 800 (or components thereof). Having thus described example head-wearable devices, attention will now be turned to example handheld intermediary processing devices, such as HIPD 1000.

### Example Handheld Intermediary Processing Devices

FIGS. 10A and 10B illustrate an example HIPD 1000, in accordance with some embodiments. The HIPD 1000 is an instance of the intermediary device mentioned above in reference to FIGS. 1A-6 herein, such that the HIPD 1000 should be understood to have the features described with respect to any intermediary device defined above or otherwise described herein, and vice versa. The HIPD 1000 can perform various functions and/or operations associated with navigating through user interfaces and selectively opening applications, as well as the functions and/or operations described above with reference to FIGS. 1A-6.

FIG. 10A shows a top view 1005 and a side view 1025 of the HIPD 1000. The HIPD 1000 is configured to communicatively couple with one or more wearable devices (or other electronic devices) associated with a user. For example, the HIPD 1000 is configured to communicatively couple with a user's wrist-wearable device 800 (or components thereof, such as the watch body 820 and the wearable band 810), AR device 900, and/or VR device 910. The HIPD 1000 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 1000 can successfully be communicatively coupled with an electronic device, such as a wearable device).

The HIPD 1000 can perform various functions independently and/or in conjunction with one or more wearable devices (e.g., wrist-wearable device 800, AR device 900, and/or VR device 910). The HIPD 1000 is configured to increase and/or improve the functionality of communicatively coupled devices, such as the wearable devices. The HIPD 1000 is configured to perform one or more functions or operations associated with interacting with user interfaces and applications of communicatively coupled devices, interacting with an AR environment, interacting with a VR environment, and/or operating as a human-machine interface controller, as well as functions and/or operations described above with reference to FIGS. 1A-6. Additionally, as will be described in more detail below, functionality and/or operations of the HIPD 1000 can include, without limitation, task offloading and/or handoffs, thermals offloading and/or handoffs, 6 degrees of freedom (6DoF) raycasting and/or gaming (e.g., using imaging devices or cameras 1014A and 1014B, which can be used for simultaneous localization and mapping (SLAM), and/or with other image processing techniques), portable charging; messaging, image capturing via one or more imaging devices or cameras (e.g., cameras 1022A and 1022B), sensing user input (e.g., sensing a touch on a multitouch input surface 1002), wireless communications and/or interlining (e.g., cellular, near-field, Wi-Fi, or personal area network), location determination, financial transactions, providing haptic feedback, alarms, notifications, biometric authentication, health monitoring, sleep monitoring. The above-example functions can be executed independently in the HIPD 1000 and/or in communication between the HIPD 1000 and another wearable device described herein. In some embodiments, functions can be executed on the HIPD 1000 in conjunction with an AR environment. As the skilled artisan will appreciate upon reading the descriptions provided herein, the novel HIPD 1000 described herein can be used with any type of suitable AR environment.

While the HIPD 1000 is communicatively coupled with a wearable device and/or other electronic device, the HIPD 1000 is configured to perform one or more operations initiated at the wearable device and/or the other electronic device. In particular, one or more operations of the wearable device and/or the other electronic device can be offloaded to the HIPD 1000 to be performed. The HIPD 1000 performs one or more operations of the wearable device and/or the other electronic device and provides data corresponding to the completed operations to the wearable device and/or the other electronic device. For example, a user can initiate a video stream using the AR device 900 and back-end tasks associated with performing the video stream (e.g., video rendering) can be offloaded to the HIPD 1000, which the HIPD 1000 performs and provides corresponding data to the AR device 900 to perform remaining front-end tasks associated with the video stream (e.g., presenting the rendered video data via a display of the AR device 900). In this way, the HIPD 1000, which has more computational resources and greater thermal headroom than a wearable device can perform computationally intensive tasks for the wearable device, improving performance of an operation performed by the wearable device.

The HIPD 1000 includes a multi-touch input surface 1002 on a first side (e.g., a front surface) that is configured to detect one or more user inputs. In particular, the multi-touch input surface 1002 can detect single-tap inputs, multi-tap inputs, swipe gestures and/or inputs, force-based and/or pressure-based touch inputs, held taps, and the like. The multi-touch input surface 1002 is configured to detect capacitive touch inputs and/or force (and/or pressure) touch inputs. The multi-touch input surface 1002 includes a first touch-input surface 1004 defined by a surface depression, and a second touch-input surface 1006 defined by a substantially planar portion. The first touch-input surface 1004 can be disposed adjacent to the second touch-input surface 1006. In some embodiments, the first touch-input surface 1004 and the second touch-input surface 1006 can be different dimensions, shapes, and/or cover different portions of the multi-touch input surface 1002. For example, the first touch-input surface 1004 can be substantially circular and the second touch-input surface 1006 is substantially rectangular. In some embodiments, the surface depression of the multi-touch input surface 1002 is configured to guide user handling of the HIPD 1000. In particular, the surface depression is configured such that the user holds the HIPD 1000 upright when held in a single hand (e.g., such that the using imaging devices or cameras 1014A and 1014B are pointed toward a ceiling or the sky). Additionally, the surface depression is configured such that the user's thumb rests within the first touch-input surface 1004.

In some embodiments, the different touch-input surfaces include a plurality of touch-input zones. For example, the second touch-input surface 1006 includes at least a first touch-input zone 1008 within a second touch-input zone 1006 and a third touch-input zone 1010 within the first touch-input zone 1008. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1008 causes the HIPD 1000 to perform a first command and a user input detected within the second touch-input zone 1006 causes the HIPD 1000 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1008 can be configured to detect force touch inputs (e.g., a magnitude at which the user presses down) and capacitive touch inputs, and the second touch-input zone 1006 can be configured to detect capacitive touch inputs.

The HIPD 1000 includes one or more sensors 1051 for sensing data used in the performance of one or more operations and/or functions. For example, the HIPD 1000 can include an IMU that is used in conjunction with cameras 1014 for 3-dimensional object manipulation (e.g., enlarging, moving, destroying, etc. an object) in an AR or VR environment. Non-limiting examples of the sensors 1051 included in the HIPD 1000 include a light sensor, a magnetometer, a depth sensor, a pressure sensor, and a force sensor. Additional examples of the sensors 1051 are provided below in reference to FIG. 10B.

The HIPD 1000 can include one or more light indicators 1012 to provide one or more notifications to the user. In some embodiments, the light indicators are LEDs or other types of illumination devices. The light indicators 1012 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1004. The light indicators can be illuminated in different colors and/or patterns to provide the user with one or more notifications and/or information about the device. For example, a light indicator positioned around the first touch-input surface 1004 can flash when the user receives a notification (e.g., a message), change red when the HIPD 1000 is out of power, operate as a progress bar (e.g., a light ring that is closed when a task is completed (e.g., 0 percent to 100 percent), operates as a volume indicator).

In some embodiments, the HIPD 1000 includes one or more additional sensors on another surface. For example, as shown FIG. 10A, HIPD 1000 includes a set of one or more sensors (e.g., sensor set 1020) on an edge of the HIPD 1000. The sensor set 1020, when positioned on an edge of the of the HIPD 1000, can be pe positioned at a predetermined tilt angle (e.g., 26 degrees), which allows the sensor set 1020 to be angled toward the user when placed on a desk or other flat surface. Alternatively, in some embodiments, the sensor set 1020 is positioned on a surface opposite the multi-touch input surface 1002 (e.g., a back surface). The one or more sensors of the sensor set 1020 are discussed in detail below.

The side view 1025 of the of the HIPD 1000 shows the sensor set 1020 and camera 1014B. The sensor set 1020 includes one or more cameras 1022A and 1022B, a depth projector 1024, an ambient light sensor 1028, and a depth receiver 1030. In some embodiments, the sensor set 1020 includes a light indicator 1026. The light indicator 1026 can operate as a privacy indicator to let the user and/or those around them know that a camera and/or microphone is active. The sensor set 1020 is configured to capture a user's facial expression such that the user can puppet a custom avatar (e.g., showing emotions, such as smiles, or laughter, on the avatar or a digital representation of the user). The sensor set 1020 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 1000 described herein can use different sensor set 1020 configurations and/or sensor set 1020 placement.

In some embodiments, the HIPD 1000 includes one or more haptic devices 1071 (FIG. 10B; e.g., a vibratory haptic actuator) that are configured to provide haptic feedback (e.g., kinesthetic sensation). The sensors 1051, and/or the haptic devices 1071 can be configured to operate in conjunction with multiple applications and/or communicatively coupled devices including, without limitation, a wearable devices, health monitoring applications, social media applications, game applications, and AR applications (e.g., the applications associated with artificial reality).

The HIPD 1000 is configured to operate without a display. However, in optional embodiments, the HIPD 1000 can include a display 1068 (FIG. 10B). The HIPD 1000 can also income one or more optional peripheral buttons 1067 (FIG. 10B). For example, the peripheral buttons 1067 can be used to turn on or turn off the HIPD 1000. Further, the HIPD 1000 housing can be formed of polymers and/or elastomer elastomers. The HIPD 1000 can be configured to have a non-slip surface to allow the HIPD 1000 to be placed on a surface without requiring a user to watch over the HIPD 1000. In other words, the HIPD 1000 is designed such that it would not easily slide off surfaces. In some embodiments, the HIPD 1000 include one or magnets to couple the HIPD 1000 to another surface. This allows the user to mount the HIPD 1000 to different surfaces and provide the user with greater flexibility in use of the HIPD 1000.

As described above, the HIPD 1000 can distribute and/or provide instructions for performing the one or more tasks at the HIPD 1000 and/or a communicatively coupled device. For example, the HIPD 1000 can identify one or more back-end tasks to be performed by the HIPD 1000 and one or more front-end tasks to be performed by a communicatively coupled device. While the HIPD 1000 is configured to offload and/or handoff tasks of a communicatively coupled device, the HIPD 1000 can perform both back-end and front-end tasks (e.g., via one or more processors, such as CPU 1077; FIG. 10B). The HIPD 1000 can, without limitation, be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1000 can perform the above operations alone or in conjunction with a wearable device (or other communicatively coupled electronic device).

FIG. 10B shows block diagrams of a computing system 1040 of the HIPD 1000, in accordance with some embodiments. The HIPD 1000, described in detail above, can include one or more components shown in HIPD computing system 1040. The HIPD 1000 will be understood to include the components shown and described below for the HIPD computing system 1040. In some embodiments, all, or a substantial portion of the components of the HIPD computing system 1040 are included in a single integrated circuit. Alternatively, in some embodiments, components of the HIPD computing system 1040 are included in a plurality of integrated circuits that are communicatively coupled.

The HIPD computing system 1040 can include a processor (e.g., a CPU 1077, a GPU, and/or a CPU with integrated graphics), a controller 1075, a peripherals interface 1050 that includes one or more sensors 1051 and other peripheral devices, a power source (e.g., a power system 1095), and memory (e.g., a memory 1078) that includes an operating system (e.g., an operating system 1079), data (e.g., data 1088), one or more applications (e.g., applications 1080), and one or more modules (e.g., a communications interface module 1081, a graphics module 1082, a task and processing management module 1083, an interoperability module 1084, an AR processing module 1085, a data management module 1086, a privacy protection module 1087 (e.g., analogous to privacy protection module 886; FIG. 8B). The HIPD computing system 1040 further includes a power system 1095 that includes a charger input and output 1096, a PMIC 1097, and a battery 1098, all of which are defined above.

In some embodiments, the peripherals interface 1050 can include one or more sensors 1051. The sensors 1051 can include analogous sensors to those described above in reference to FIGS. 8B. For example, the sensors 1051 can include imaging sensors 1054, (optional) EMG sensors 1056, IMUs 1058, and capacitive sensors 1060. In some embodiments, the sensors 1051 can include one or more pressure sensor 1052 for sensing pressure data, an altimeter 1053 for sensing an altitude of the HIPD 1000, a magnetometer 1055 for sensing a magnetic field, a depth sensor 1057 (or a time-of flight sensor) for determining a difference between the camera and the subject of an image, a position sensor 1059 (e.g., a flexible position sensor) for sensing a relative displacement or position change of a portion of the HIPD 1000, a force sensor 1061 for sensing a force applied to a portion of the HIPD 1000, and a light sensor 1062 (e.g., an ambient light sensor) for detecting an amount of lighting. The sensors 1051 can include one or more sensors not shown in FIG. 10B.

Analogous to the peripherals described above in reference to FIGS. 8B, the peripherals interface 1050 can also include an NFC component 1063, a GPS component 1064, an LTE component 1065, a Wi-Fi and/or Bluetooth communication component 1066, a speaker 1069, a haptic device 1071, and a microphone 1073. As described above in reference to FIG. 10A, the HIPD 1000 can optionally include a display 1068 and/or one or more buttons 1067. The peripherals interface 1050 can further include one or more cameras 1070, touch surfaces 1072, and/or one or more light emitters 1074. The multi-touch input surface 1002 described above in reference to FIG. 10A is an example of touch surface 1072. The light emitters 1074 can be one or more LEDs, lasers, etc. and can be used to project or present information to a user. For example, the light emitters 1074 can include light indicators 1012 and 1026 described above in reference to FIG. 10A. The cameras 1070 (e.g., cameras 1014A, 1014B, and 1022 described above in FIG. 10A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1070 can be used for SLAM; 6 DoF ray casting, gaming, object manipulation, and/or other rendering; facial recognition and facial expression recognition, etc.

Similar to the watch body computing system 860 and the watch band computing system 830 described above in reference to FIG. 8B, the HIPD computing system 1040 can include one or more haptic controllers 1076 and associated componentry (e.g., haptic devices 1071) for providing haptic events at the HIPD 1000.

Memory 1078 can include high-speed random-access memory and/or non-volatile memory, such as one or more magnetic disk storage devices, flash memory devices, or other non-volatile solid-state memory devices. Access to the memory 1078 by other components of the HIPD 1000, such as the one or more processors and the peripherals interface 1050, can be controlled by a memory controller of the controllers 1075.

In some embodiments, software components stored in the memory 1078 include one or more operating systems 1079, one or more applications 1080, one or more communication interface modules 1081, one or more graphics modules 1082, one or more data management modules 1085, which are analogous to the software components described above in reference to FIG. 8B. The software components stored in the memory 1078 can also include a privacy protection module 1086A, which is configured to perform the features described above in reference to FIGS. 1A-6.

In some embodiments, software components stored in the memory 1078 include a task and processing management module 1083 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1083 uses data 1088 (e.g., device data 1090) to distribute the one or more front-end and/or back-end tasks based on communicatively coupled devices' computing resources, available power, thermal headroom, ongoing operations, and/or other factors. For example, the task and processing management module 1083 can cause the performance of one or more back-end tasks (of an operation performed at communicatively coupled AR device 900) at the HIPD 1000 in accordance with a determination that the operation is utilizing a predetermined amount (e.g., at least 70 percent) of computing resources available at the AR device 900.

In some embodiments, software components stored in the memory 1078 include an interoperability module 1084 for exchanging and utilizing information received and/or provided to distinct communicatively coupled devices. The interoperability module 1084 allows for different systems, devices, and/or applications to connect and communicate in a coordinated way without user input. In some embodiments, software components stored in the memory 1078 include an AR module 1085 that is configured to process signals based at least on sensor data for use in an AR and/or VR environment. For example, the AR processing module 1085 can be used for 3D object manipulation, gesture recognition, facial and facial expression, recognition, etc.

The memory 1078 can also include data 1088, including structured data. In some embodiments, the data 1088 can include profile data 1089, device data 1090 (including device data of one or more devices communicatively coupled with the HIPD 1000, such as device type, hardware, software, configurations, etc.), sensor data 1091, media content data 1092, application data 1093, and privacy protection data 1094 (e.g., analogous to privacy protection data 892; FIG. 8B), which stores data related to the performance of the features described above in reference to FIGS. 1A-6.

It should be appreciated that the HIPD computing system 1040 is an example of a computing system within the HIPD 1000, and that the HIPD 1000 can have more or fewer components than shown in the HIPD computing system 1040, combine two or more components, and/or have a different configuration and/or arrangement of the components. The various components shown in HIPD computing system 1040 are implemented in hardware, software, firmware, or a combination thereof, including one or more signal processing and/or application-specific integrated circuits.

The techniques described above in FIG. 10A-10B can be used with any device used as a human-machine interface controller. In some embodiments, an HIPD 1000 can be used in conjunction with one or more wearable device such as a head-wearable device (e.g., AR device 900 and VR device 910) and/or a wrist-wearable device 800 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by one or more processors of a head-wearable device, cause the head-wearable device to:
detect, via an ambient light sensor of the head-wearable device, a first amount of light in an environment;
detect, via an imaging device of the head-wearable device, a second amount of light in the environment;
responsive to a user input for capturing image data via the imaging device of the head-wearable device, determine a brightness ratio, wherein the brightness ratio is based on a relationship between the first amount of light and the second amount of light in the environment;
in accordance with a determination that the brightness ratio satisfies a tamper threshold, capture image data; and
in accordance with a determination that the brightness ratio does not satisfy the tamper threshold, forgo capturing image data.

2. The non-transitory computer readable storage medium of claim 1, wherein the tamper threshold is a first tamper threshold or a second tamper threshold, and the instructions, when executed by the one or more processors of the head-wearable device, further cause the head-wearable device to:
before determining whether the brightness ratio satisfies the tamper threshold, determine whether the first amount of light in the environment satisfies a brightness threshold;
in accordance with a determination that the first amount of light in the environment satisfies the brightness threshold, use the first tamper threshold as the tamper threshold; and
in accordance with a determination that the first amount of light in the environment does not satisfy the brightness threshold, use the second tamper threshold as the tamper threshold.

3. The non-transitory computer readable storage medium of claim 1, wherein the instructions, when executed by the one or more processors of the head-wearable device, further cause the head-wearable device to:
prior to detecting the first amount of light and the second amount of light in the environment, calibrate the ambient light sensor and the imaging device.

4. The non-transitory computer readable storage medium of claim 1, wherein the instructions, when executed by the one or more processors of the head-wearable device, further cause the head-wearable device to:
before determining the brightness ratio:
determine, for the ambient light sensor of the head-wearable device, a first field of view;
determine, for the imaging device of the head-wearable device, a second field of view; and
based on a comparison of the first field of view and the second field of view, select a matching field of view,
wherein the determination of the brightness ratio is based on the relationship between the first amount of light and the second amount of light within the matching field of view.

5. The non-transitory computer readable storage medium of claim 1, wherein the instructions, when executed by the one or more processors of the head-wearable device, further cause the head-wearable device to:
before determining the brightness ratio:
in accordance with a determination, based on a comparison of the first amount of light and the second amount of light, that respective amounts of lights detected by the ambient light sensor and the imaging device are not uniformly distributed within respective fields of view of the ambient light sensor and the imaging device:
superimpose a portion of the first amount of light on the second amount of light; and
update the second amount of light to include the portion of the first amount of light superimposed on the second amount of light.

6. The non-transitory computer readable storage medium of claim 1, wherein the instructions, when executed by the one or more processors of the head-wearable device, further cause the head-wearable device to:
in accordance with the determination that the brightness ratio does not satisfy the tamper threshold, provide a notification to a user of the head-wearable device, the notification including suggestions for satisfying the tamper threshold.

7. The non-transitory computer readable storage medium of claim 1, wherein the instructions, when executed by the one or more processors of the head-wearable device, further cause the head-wearable device to:
detect, via a capacitance sensor of the head-wearable device, a capacitance value at a portion of the head-wearable device,
responsive to the user input for capturing image data via the imaging device of the head-wearable device:
in accordance with a determination that the capacitance value is within a predetermined tamper capacitance threshold, forgo capturing image data; and
in accordance with a determination that the capacitance value is not within the predetermined tamper capacitance threshold, capture the image data.

8. The non-transitory computer readable storage medium of claim 1, wherein the instructions, when executed by the one or more processors of the head-wearable device, further cause the head-wearable device to:
detect, via a proximity sensor of the head-wearable device, presence of an object in proximity to a portion of the head-wearable device,
responsive to the user input for capturing image data via the imaging device of the head-wearable device:
in accordance with a determination that the object in proximity to the portion of the head-wearable device is within a predetermined tamper distance threshold, forgo capturing image data; and
in accordance with a determination that the object in proximity to the portion of the head-wearable device is not within a predetermined tamper distance threshold, capture the image data.

9. A head-wearable device, comprising:
an ambient light sensor;
an imaging device;
a privacy indicator; and
one or more programs, wherein the one or more programs are stored in memory and configured to be executed by one or more processors, the one or more programs including instructions for causing a performance of:
detecting, via an ambient light sensor of the head-wearable device, a first amount of light in an environment;
detecting, via an imaging device of the head-wearable device, a second amount of light in the environment;
responsive to a user input for capturing image data via the imaging device of the head-wearable device, determining a brightness ratio, wherein the brightness ratio is based on a relationship between the first amount of light and the second amount of light in the environment;
in accordance with a determination that the brightness ratio satisfies a tamper threshold, capturing image data; and
in accordance with a determination that the brightness ratio does not satisfy the tamper threshold, forgoing capturing image data.

10. The head-wearable device of claim 9, wherein:
the imaging device is disposed on a first frame portion of the head-wearable device; and
the ambient light sensor and the privacy indicator are disposed on a second frame portion, opposite the first frame portion, of the head-wearable device.

11. The head-wearable device of claim 9, wherein:
the ambient light sensor, the imaging device, and the privacy indicator are disposed on a first frame portion of the head-wearable device; and
the privacy indicator is configured to illuminate a perimeter of the first frame portion of the head-wearable device, wherein the perimeter of the first frame portion outlines one or both of the ambient light sensor and the imaging device.

12. The head-wearable device of claim 9, wherein the one or more programs include further instructions for causing the performance of:
prior to detecting the first amount of light and the second amount of light in the environment, calibrating the ambient light sensor and the imaging device.

13. The head-wearable device of claim 9, wherein the one or more programs include further instructions for causing the performance of:
before determining the brightness ratio:
determining, for the ambient light sensor of the head-wearable device, a first field of view;
determining, for the imaging device of the head-wearable device, a second field of view; and
based on a comparison of the first field of view and the second field of view, selecting a matching field of view,
wherein the determination of the brightness ratio is based on the relationship between the first amount of light and the second amount of light within the matching field of view.

14. The head-wearable device of claim 9, wherein the one or more programs include further instructions for causing the performance of:
before determining the brightness ratio:
in accordance with a determination, based on a comparison of the first amount of light and the second amount of light, that respective amounts of lights detected by the ambient light sensor and the imaging device are not uniformly distributed within respective fields of view of the ambient light sensor and the imaging device:
superimposing a portion of the first amount of light on the second amount of light; and
updating the second amount of light to include the portion of the first amount of light superimposed on the second amount of light.

15. The head-wearable device of claim 9, wherein the one or more programs include further instructions for causing the performance of:
in accordance with the determination that the brightness ratio does not satisfy the tamper threshold, providing a notification to a user of the head-wearable device, the notification including suggestions for satisfying the tamper threshold.

16. A method, comprising:
detecting, via an ambient light sensor of a head-wearable device, a first amount of light in an environment;
detecting, via an imaging device of the head-wearable device, a second amount of light in the environment;
responsive to a user input for capturing image data via the imaging device of the head-wearable device, determining a brightness ratio, wherein the brightness ratio is based on a relationship between the first amount of light and the second amount of light in the environment;
in accordance with a determination that the brightness ratio satisfies a tamper threshold, capturing image data; and
in accordance with a determination that the brightness ratio does not satisfy the tamper threshold, forgoing capturing image data.

17. The method of claim 16, wherein the tamper threshold is a first tamper threshold or a second tamper threshold, and the method further comprises:
before determining whether the brightness ratio satisfies the tamper threshold, determine whether the first amount of light in the environment satisfies a brightness threshold;
in accordance with a determination that the first amount of light in the environment satisfies the brightness threshold, use the first tamper threshold as the tamper threshold; and
in accordance with a determination that the first amount of light in the environment does not satisfy the brightness threshold, use the second tamper threshold as the tamper threshold.

18. The method of claim 17, further comprising:
prior to detecting the first amount of light and the second amount of light in the environment, calibrating the ambient light sensor and the imaging device.

19. The method of claim 17, further comprising:
before determining the brightness ratio:
determining, for the ambient light sensor of the head-wearable device, a first field of view;
determining, for the imaging device of the head-wearable device, a second field of view; and
based on a comparison of the first field of view and the second field of view, selecting a matching field of view,
wherein the determination of the brightness ratio is based on the relationship between the first amount of light and the second amount of light within the matching field of view.

20. The method of claim 17, further comprising:
before determining the brightness ratio:
in accordance with a determination, based on a comparison of the first amount of light and the second amount of light, that respective amounts of lights detected by the ambient light sensor and the imaging device are not uniformly distributed within respective fields of view of the ambient light sensor and the imaging device:
superimposing a portion of the first amount of light on the second amount of light; and
updating the second amount of light to include the portion of the first amount of light superimposed on the second amount of light.
